(19) United States
(12) Patent Application Publication
(10) Pub. No.: US 2026/0166496 A1
(43) Pub. Date: Jun. 18, 2026

(54) FILTRATION APPARATUS COMPRISING POLYMER MODIFIED GRAPHENE OXIDE MEMBRANES

(71) Applicant: Via Separations, Inc., Watertown, MA (US)

(72) Inventors: Stephen FRAYNE, Wayland, MA (US); Sarah N. ELLIS, Cambridge, MA (US); Lymaris ORTIZ RIVERA, Waltham, MA (US); Michelle MacLeod, Boston, MA (US); Brent D. KELLER, Somerville, MA (US)

(21) Appl. No.: 19/532,984

(22) Filed: Feb. 6, 2026

Related U.S. Application Data
(63) Continuation of application No. PCT/US2024/041589, filed on Aug. 8, 2024.
(60) Provisional application No. 63/531,750, filed on Aug. 9, 2023.

(51) Int. Cl. B01D 71/02; B01D 67/00; B01D 69/06; B01D 69/10; B01D 71/60

(52) U.S. Cl. CPC B01D 71/0211; B01D 67/0046; B01D 67/00793; B01D 67/0095; B01D 69/06; B01D 69/1071; B01D 71/601; B01D 2323/21838; B01D 2323/21839; B01D 2323/48

(57) ABSTRACT

Filtration apparatus comprising Graphene Oxide (GO) membranes modified by incorporation of polymeric components are described herein. The GO membranes include graphene oxide sheets covalently coupled to one or more polymeric components. Incorporation of polymeric components may increase d-spacing of the graphene oxide sheets resulting in improved filtration apparatus performance with respect to prior art membranes (e.g., high flux and rejection rate). In some embodiments the polymeric components may comprise branched polymers with primary amine functionalities which can act as efficient handles for covalent attachment to graphene oxide, resulting in the formation of new, robust amide bonds. The filtration apparatus described herein can exhibit improved performance in applications such as pulp and paper processing, which facilitates achieving permeate quality targets.

### CROSS-REFERENCE TO RELATED APPLICATIONS

This application is a continuation of International Patent Application No. PCT/US2024/041589, entitled “Filtration Apparatus Comprising Polymer Modified Graphene Oxide Membranes,” filed Aug. 8, 2024, which claims the benefit of U.S. Provisional application No. 63/531,750, entitled “Filtration Apparatus Comprising Polymer Modified Graphene Oxide Membranes,” filed Aug. 9, 2023, the disclosure of each of which is incorporated by reference herein in its entirety.

### TECHNICAL FIELD

The present disclosure generally relates to graphene oxide membranes and their use in separation processes.

### BACKGROUND

Membranes can be used to separate a mixture by passing some components (filtrate or permeate) and retaining others preferentially with a balance of the mixture (rejects) according to any of a variety of properties of the membrane and/or of the components of the material being filtered. For example, membranes can be configured to separate rejects from a filtrate based on size exclusion (i.e., a physical barrier such as pores that are smaller than the excluded particles). Other examples include membranes that are configured to separate rejects from a filtrate based on chemical, electrochemical, and/or physical binding with one or more components of the material being filtered.

Polymer membranes are a common type of membrane. They have been used commercially in a wide range of applications including water softening, desalination, and for the concentration, removal, and purification of different salts, small molecules, and macromolecules. However, in certain environments (e.g., oxidizing conditions, high pH, high temperatures, or in some solvents), polymer membranes can become damaged or fail due to swelling, oxidation reactions, degradation, or softening of the polymer. Graphene oxide membranes are a relatively new type of membrane prepared and/or fabricated using an oxidized form of graphene, a material recognized for its superior mechanical properties and chemical stability. While graphene oxide membranes hold a lot of promise, there remains a challenge to chemically engineer a graphene oxide membrane to achieve the desired filtration characteristics such as high conductivity rejection, selective for different species, and high flux. Accordingly, there is a need in the art for new membranes that address one or more deficiencies of the membranes in the prior art.

### SUMMARY

One aspect of the present disclosure relates to a filtration apparatus. In some embodiments, a filtration apparatus can comprise a support substrate; and a graphene oxide membrane disposed on the support substrate. The graphene oxide membrane includes a plurality of graphene oxide sheets, each of the graphene oxide sheets from the plurality of graphene oxide sheets coupled to a polymeric component. The graphene oxide membrane has a total solids rejection rate of at least about 50% and a flux of at least about 4 gallons per square foot per day (GFD) in flowing a weak black liquor solution at a cross flow velocity of at least 0.1 m/sec at a predetermined temperature and a pressure of at least about 100 psi.

In some embodiments, a filtration apparatus can comprise a support; a graphene oxide membrane disposed on the support, the graphene oxide membrane comprising a plurality of graphene oxide layers, each graphene oxide layer including at least one graphene oxide sheet covalently coupled to a chemical spacer; and a polymeric additive disposed on the graphene oxide membrane. The filtration apparatus can be characterized by a lactose rejection rate with a 1 wt % lactose solution and a MgSO₄ rejection rate with a 0.1 wt % MgSO₄ solution, with the lactose rejection rate being at least about 20% greater than the MgSO₄ rejection rate.

Another aspect of the present relates a method for fabricating graphene oxide membranes. In some embodiment, a method for fabricating a graphene oxide membrane includes: dispersing a plurality of graphene oxide sheets in an aqueous solution; adjusting a pH of the aqueous solution to between about 7.0 to 10; adding a polymeric component and at least one carbodiimide additive to the aqueous solution; and after adding the polymeric component and the at least one carbodiimide additive, stirring the aqueous solution for a period of time at a predetermined temperature. The method can further include after the adding and the stirring, casting the aqueous solution on a support substrate; and drying the aqueous solution on the support substrate to produce the graphene oxide membrane.

### BRIEF DESCRIPTION OF THE DRAWINGS

FIG. 1A is a schematic illustration of a filtration apparatus 1000 in accordance with some embodiments of the present disclosure.

FIG. 1B is a schematic illustration of polymer-modified graphene oxide membrane included in a filtration apparatus 1000 in accordance with some embodiments of the present disclosure.

FIG. 2A is a schematic illustration of a filtration apparatus 1000′ in accordance with some embodiments of the present disclosure.

FIG. 2B is a schematic illustration of a graphene oxide membrane 100B included in a filtration apparatus 1000′ in accordance with some embodiments of the present disclosure. The graphene oxide membrane 100B comprises a plurality of graphene oxide sheets, wherein each of the graphene oxide sheets is not covalently crosslinked to the adjacent graphene oxide sheet.

FIG. 2C is a schematic illustration of a graphene oxide membrane 100C included in a filtration apparatus 1000′ in accordance with some embodiments of the present disclosure. The graphene oxide membrane 100C comprises a plurality of graphene oxide sheets, wherein each of the graphene oxide sheets is covalently crosslinked to the adjacent graphene oxide sheet.

FIG. 3 shows an example chemical reaction between carboxylic acid functional groups present in graphene oxide (GO) and amine functional groups included on a polymeric component (polyethyleneimine, PEI), which produces a polymer-modified graphene oxide (PEI-GO) membrane, according to some embodiments.

FIG. 4 shows Fourier Transformed Infrared (FTIR) spectra of graphene oxide (GO), a polyethyleneimine (PEI) polymeric component (PEI average molecular weight ˜25 kDa), and a 25 kDa PEI-GO polymer-modified graphene oxide membrane recorded at room temperature.

FIG. 5 shows thermogravimetric analysis (TGA) curves of a graphene oxide (GO) sample, a PEI polymeric component sample (PEI average molecular weight ˜25 kDa), and a 25 kDa PEI-GO polymer-modified graphene oxide membrane sample.

FIGS. 6A and 6B show scanning electron microscopy (SEM) images and accompanying Energy Dispersive Spectroscopy (EDS) graphs recorded on the surface of a 25 kDa PEI-GO polymer-modified graphene oxide membrane sample.

FIG. 7 shows a graph displaying the rejection (%) and flux (in gallons per square foot per day, or GFD) of a 1.8 kDa PEI-GO polymer-modified graphene oxide membrane, and a graphene oxide membrane comprising a propionamide chemical spacer (ps-GO membrane), measured as a function of time flowing a Weak Black Liquor (WBL) solution at a temperature of at least 55° C., a cross flow velocity of 0.1 m/sec and a pressure of 300 psi.

FIG. 8 shows a graph displaying rejection rate (%) and flux (GFD) of a 25 kDa PEI-GO polymer-modified graphene oxide membrane, and a graphene oxide membrane comprising a propionamide chemical spacer (ps-GO membrane), measured as a function of time flowing a Weak Black Liquor (WBL) solution at a temperature of at least 55° C., a cross flow velocity of 0.1 m/sec, and a pressure of 300 psi.

FIG. 9A shows an X-Ray Photoelectron Spectroscopy (XPS) survey spectrum of a first polymer-modified graphene oxide (PEI-GO) membrane sample (PEI average molecular weight ˜25 kDa) fabricated according to an embodiment of the present disclosure.

FIG. 9B shows a table depicting the carbon (C1S peak) chemical composition analysis obtained from the XPS spectrum shown in FIG. 9A.

FIG. 10A shows an X-Ray Photoelectron Spectroscopy (XPS) survey spectrum of a second polymer-modified graphene oxide (PEI-GO) membrane sample (PEI average molecular weight ˜25 kDa) fabricated according to an embodiment of the present disclosure.

FIG. 10B shows a table depicting the carbon (C1S peak) chemical composition analysis obtained from the XPS spectrum shown in FIG. 10A.

### DETAILED DESCRIPTION

Graphite is a crystalline form of carbon with its atoms arranged in a hexagonal structure layered in a series of planes. Due to its abundance on earth, graphite is very cheap and is commonly used in pencils and lubricants. Graphene is a single, one atomic layer of carbon atoms (i.e., one of the layers of graphite) with several exceptional electrical, mechanical, optical, and electrochemical properties, earning it the nickname “the wonder material.” To name just a few, it is highly transparent, extremely light and flexible yet robust, and an excellent electrical and thermal conductor. Such extraordinary properties render graphene and related thinned graphite materials (e.g., few layer graphene) as promising candidates for a diverse set of applications. For example, graphene can be used in coatings to prevent steel and aluminum from oxidizing, and to filter salt, heavy metals, and oil from water.

Graphene oxide is an oxidized form of graphene having oxygen-containing pendant functional groups (e.g., epoxide, carboxylic acid, or hydroxyl) that exist in the form of single atom thick sheets. By oxidizing the graphene in graphite, graphene oxide sheets can be produced. For example, the graphene oxide sheets can be prepared from graphite using a modified Hummers method. Flake graphite is oxidized in a mixture of KMnO₄, H₂SO₄, and/or NaNO₃, then the resulting pasty graphene oxide was diluted and washed through cycles of filtration, centrifugation, and resuspension. The washed graphene oxide suspension is subsequently ultrasonicated to exfoliate graphene oxide particles into graphene oxide sheets and centrifuged at high speed to remove unexfoliated graphite residues. The resulting yellowish/light brown solution is the final graphene oxide sheet suspension. This color indicates that the carbon lattice structure is distorted by the added oxygenated functional groups. The produced graphene oxide sheets are hydrophilic and can stay suspended in water for months without a sign of aggregation or deposition.

Due in part for its low cost, high chemical stability, strong hydrophilicity, and compatibility with a variety of environments, graphene oxide has been explored for its use as membranes in filtration applications. For example, as compared to polymer membranes (e.g., membranes made entirely of a polymeric material), which can be prone to oxidation, graphene oxide membranes can remain stable under oxidizing conditions. Graphene oxide membranes can also be formed into stacked layers by orienting a large majority of the graphene oxide sheets parallel to each other. The distance between stack layers, also referred to as the interlayer spacing and/or d-spacing, tends to be relatively small, which provides graphene oxide membranes a controlled molecular weight cutoff. Furthermore, in some instances, the d-spacing of graphene oxide membranes can be fine-tuned via chemical and/or physical treatments, resulting in high rejection rates suitable for multiple filtration applications.

Despite these advantages, the performance of existing graphene oxide membranes can be negatively impacted by a number of deficiencies. For example, graphene oxide membranes can experience limited and/or reduced durability when exposed to high temperatures or acidic/basic conditions. Some existing graphene oxide membranes can achieve high rejection rates when used in reverse osmosis applications at room temperature. However, after exposure to high temperatures (e.g., greater than about 50° C.) and/or highly alkaline pH environments (e.g., pH=11) for a period of time the performance of these graphene oxide membranes diminishes. Existing graphene oxide membranes can also suffer from small and/or reduced flux, which limits and, in some instances, precludes their use in filtration applications that involve large flowrates and/or large volumes. Without being bound by any particular theory, it is believed that the relatively small d-spacing of stacked layers in graphene oxide membranes leads to controlled molecular weight cutoff and high rejection rates for a wide range of species of interest in filtration applications. However, that small d-spacing can also translate into small flux and/or high pressure drop during filtration operations. Existing graphene oxide membranes can also be unsuitable for applications that require selectively rejecting unwanted and/or undesired species, while permitting diffusion of other species of interest. Said in other words, existing graphene oxide membranes have limited ability to decouple the rejection rates of small molecules such as sugar (e.g., lactose) and salt (e.g., MgSO4). For example, some existing graphene oxide membranes can achieve high rejection rates for lactose, however, the high lactose rejection rate is accompanied by a similarly high rejection rate for MgSO4, which renders the membrane ineffective for certain filtration applications in which only one of the two species (e.g., lactose or MgSO4) is desired. The present disclosure provides filtration systems and graphene oxide membranes that address the limitations of current graphene oxide membranes and exhibit one or more superior properties over existing graphene oxide membranes. More specifically, the present application describes filtration systems and/or apparatus that incorporate selected polymeric materials to improve the performance characteristics of graphene oxide membranes such as flux, durability, thermal stability, and/or selectivity. In some embodiments, the filtration apparatus described herein can incorporate one or more polymeric additives disposed on a graphene oxide membrane to produce membranes having tunable selectivity for the rejection of certain species while permitting diffusion of other species. In some embodiments, the filtration apparatus described herein can incorporate selected polymeric components in between graphene oxide sheets, producing polymer-modified graphene oxide membranes having increased d-spacing. These polymer-modified graphene oxide membranes can retain the key properties of conventional graphene oxide membranes including the stability under high temperatures and/or highly alkaline pH environments, chemical affinity, and high rejection rates, while exhibiting a significantly improved flux owing to their increased d-spacing. The polymeric additives and/or polymer-modified graphene oxide membranes described herein can be integrated into a filtration apparatus that exhibits high flux, high rejection rates, and tunable selectivity for a wide variety of filtration applications.

### Filtration Apparatus

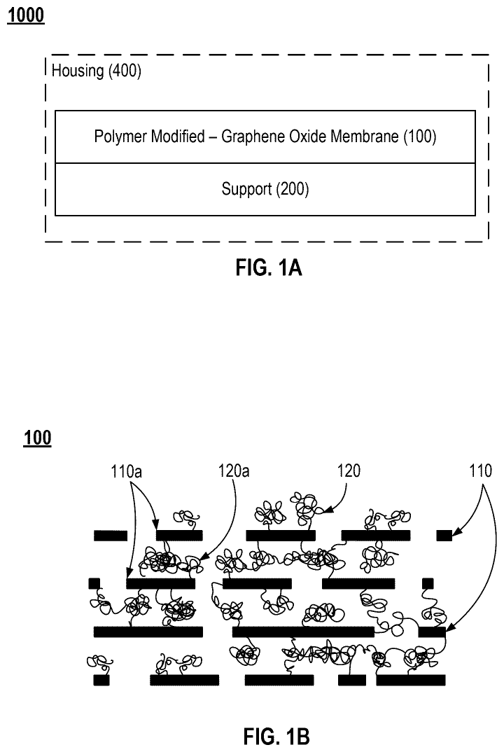

FIG. 1A shows a schematic illustration of a filtration apparatus 1000 according to some embodiment of the present disclosure. The filtration apparatus 1000 includes a polymer-modified graphene oxide membrane 100, a support 200, and optionally a housing 400. The polymer-modified graphene oxide membrane 100 can be disposed on the support 200, and the optional housing 400 can enclose the support 200 and the polymer-modified graphene oxide membrane 100.

In some embodiments, the polymer-modified graphene oxide membrane 100 and the support 200 can have a combined thickness of about 50 μm to about 1300 μm, (e.g., about 50 μm, about 60 μm, about 80 μm, about 100 μm, about 150 μm, about 200 μm, about 250 μm, about 300 μm, about 350 μm, about 400 μm, about 450 μm, about 500 μm, about 550 μm, about 600 μm, about 650 μm, about 700 μm, about 750 μm, about 800 μm, about 850 μm, about 900 μm, about 950 μm, about 1000 μm, about 1100 μm, about 1200 μm, or about 1300 μm, including any values and subranges in between.) For example, in some embodiments the polymer-modified graphene oxide membrane 100 and the support 200 can have a combined thickness of about 100 μm to about 750 μm, about 200 μm to about 1000 μm, or about 200 μm to about 1200 μm, inclusive of all values and ranges therebetween.

The support 200 can be a substrate material that provides strength and/or mechanical properties to the filtration apparatus 1000. The support 200 can act as a protective layer that prevents damage of the polymer-modified graphene oxide membrane 100 and other components of the filtration apparatus 1000. For example, the support 200 can protect the polymer-modified graphene oxide membrane 100 from damage (e.g., formation of pinholes, punctures, cracks, or other mechanical stress-induce defects) resulting from the fabrication of spiral membranes, and/or during operation and/or use of the filtration apparatus 1000 under harsh environment conditions (high pressure, highly alkaline conditions, extended periods of time, etc.).

In some embodiments, the support 200 can have a thickness of no more than about 1200 μm, no more than about 1000 μm, no more than about 800 μm, no more than about 600 μm, no more than about 400 μm, no more than about 200 μm, nor more than about 100 μm, or no more than about 45 μm, inclusive of all values and ranges therebetween. In some embodiments, the support 200 can have a thickness of at least about 75 μm, at least about 100 μm, or at least about 200 μm, inclusive of all values and ranges therebetween.

Combinations of the above referenced ranges for the thickness of the support 200 are also possible (e.g., a thickness of at least about 75 μm to no more than about 1200 μm, at least about 100 μm to no more than about 1000 μm).

The support 200 can include a non-woven fiber or polymer. In some embodiments, the support 200 can include a material selected from polypropylene (PP), polystyrene, polyethylene, polyethylene oxide, polyethersulfone (PES), polytetrafluoroethylene (PTFE), polyvinylidene fluoride, polymethylmethacrylate, polydimethylsiloxane, polyester, polyolefin, cellulose, cellulose acetate, cellulose nitrate, polyacrylonitrile, glass fiber, quartz, alumina, silver, polycarbonate, nylon, Kevlar or other aramid, or polyether ether ketone.

In some embodiments, the support 200 can be a porous substrate. The support 200 can have an average pore size of about 0.002 μm to about 10 μm, e.g., about 0.01 μm to about 10 μm, about 0.1 μm to about 8 μm, about 0.1 μm to about 1 μm, about 0.2 μm to about 5 μm, about 0.2 μm to about 2 μm, or about 0.2 μm to about 1 μm. In some embodiments, the support 200 can have an average pore size less than 1 μm, such as about 0.002 μm, about 0.004 μm, about 0.006 μm, about 0.008 μm, about 0.01 μm, about 0.04 μm, about 0.1 μm, about 0.3 μm, about 0.5 μm, about 0.6 μm, about 0.65 μm, about 0.7 μm, or about 0.75 μm.

In some embodiments, the support 200 can include two or more layers. For example, the support 200 can include a first layer and a second layer, the first layer is disposed on the second layer, wherein the first layer and the second layer have different average pore sizes. In some embodiments, the polymer-modified graphene oxide membrane 100 is disposed on the first layer, and the first layer has a smaller average pore size than the second layer.

In some embodiments, the roughness of the support 200 can have an impact on the flux performance of the filtration apparatus. Specifically, a smooth support can improve the flux and/or rejection rate of the filtration apparatus 1000 as compared to a rough support. Accordingly, in some embodiments, the support 200 can be smooth. For example, the support 200 can have a root mean squared surface roughness of less than about 3 μm, less than about 2.5 μm, less than about 2 μm, less than about 1.5 μm, or less than about 1 μm. In some embodiments, the support 200 can have a root mean squared surface roughness of at least about 1 μm, at least about 1.2 μm, at least about 1.4 μm, at least about 1.5 μm, inclusive of all values and ranges therebetween. In some embodiments, the surface roughness is measured by a Dektak 6M Contact Profilometer.

Combinations of the above-referenced ranges for the root mean squared surface roughness are also possible (e.g., at least about 1 μm to less than 2.5 μm, or at least 1.4 μm to less than about 3 μm). In some embodiments, the support 200 has a root mean squared surface roughness of about 3 μm, about 2.5 μm, about 2 μm, about 1.5 μm, or about 1 μm.

In some embodiments the support 200 can comprise a hollow polymer tube. The hollow polymer tube can have a surface area greater than or equal to about 100 cm².

In some embodiments, the filtration apparatus 1000 can comprise a plurality of flat polymer sheets combined to form a spiral filtration module. For example, in some embodiments, a spiral filtration module can comprise a plurality of flat polymer sheets stacked atop one another, and the plurality of stacked flat polymer sheets may be rolled around a core tube. In some embodiments, prior to being rolled around the core tube, adjacent flat polymer sheets may be separated by a sheet of feed channel spacer to form a leaf, and each leaf may be separated by a sheet of permeate spacer. When the flat polymer sheets, the one or more feed channel spacers, and the one or more permeate spacers are rolled around the core tube, each permeate spacer may form a permeate channel.

In some embodiments, the filtration apparatus 1000 includes about 0.1 mg to 6 mg of the polymer-modified graphene oxide membrane 100 per 5000 mm². In some embodiments, the filtration apparatus 1000 includes about 0.1 mg to 5 mg, about 0.1 mg to 4 mg, about 0.1 mg to 3 mg, about 0.5 mg to 5 mg, about 0.5 mg to 4 mg, about 0.5 mg to 3 mg, about 1 mg to 4 mg, or about 1 mg to 3 mg of the polymer-modified graphene oxide membrane 100 per 5000 mm². For example, the filtration apparatus 1000 can include about 1 mg, about 1.5 mg, about 2 mg, about 2.5 mg, or about 3 mg of the polymer-modified graphene oxide membrane 100 per 5000 mm².

FIG. 1B presents a schematic diagram of the structure of the polymer-modified graphene oxide membrane 100 shown in FIG. 1A. The polymer-modified graphene oxide membrane 100 includes a plurality of graphene oxide (GO) sheets 110 and one or more polymeric components 120 coupled to the GO sheets 110. The GO sheets 110 can be arranged and/or oriented generally parallel to each other forming one or more stacked layers. The spacing (e.g., d-spacing) between GO sheets 110 can be either interlayer spacing or intralayer spacing. The spacing between the GO sheet 110 can be engineered to control the molecular weight cutoff and the flux properties of the polymer-modified graphene oxide membrane 100, as further described herein.

In some embodiments, the polymer-modified graphene oxide membrane 100 can have a thickness greater than or equal to about 25 nm, greater than or equal to about 50 nm, greater than or equal to about 0.1 microns, greater than or equal to about 0.15 microns, greater than or equal to about 0.2 microns, greater than or equal to about 0.3 microns, greater than or equal to about 0.4 microns, greater than or equal to about 0.5 microns, greater man or equal to about 0.75 microns, greater than or equal to about 1 micron, greater than or equal to about 2 microns. In some embodiments, the thickness of the polymer-modified graphene oxide membrane 100 may be less than or equal to about 5 microns, less than or equal to about 1 micron, less than or equal to about 0.75 microns, less than or equal to about 0.5 microns.

Combinations of the above-referenced ranges for the thickness of the polymer-modified graphene oxide membrane 100 are also possible (e.g., greater than or equal to about 25 nm to less than or equal to about 5 microns, greater than or equal to about 0.15 microns to less than or equal to about 0.6 microns).

In some embodiments, the polymer-modified graphene oxide membrane 100 can have an average pore size of greater than or equal to about 0.5 nm, greater than or equal to about 1 nm, greater than or equal to about 2 nm, greater than or equal to about 3 nm, greater than or equal to about 4 nm, or greater than or equal to about 5 nm. In some embodiments, the polymer-modified graphene oxide membrane 100 can have an average pore size of less than or equal to about 6 nm, less than or equal to about 5 nm, less than or equal to about 4 nm, less than or equal to about 3 nm, or less than or equal to about 2 nm, inclusive of all values and ranges therebetween.

Combinations of the above-referenced ranges for the average pore size are also possible (e.g., greater than or equal to about 0.5 nm to less than or equal to about 6 nm, greater than or equal to about 1 nm to less than or equal to about 6 nm). In some embodiments, the polymer-modified graphene oxide membrane 100 can have an average pore size of about 0.5 nm, about 0.8 nm, about 1 nm, about 2 nm, about 3 nm, about 4 nm, about 5 nm, or about 6 nm.

The GO sheets 110 can include flakes. The flakes can have an aspect ratio (on the plane of the GO sheets 110). In some embodiments, the aspect ratio can be less than about 250,000:1, less than about 100,000:1, less than about 50,000:1, less than about 25,000:1, less than about 10,000:1, less than about 5,000:1, less than about 1,000:1. In some embodiment, the flakes can have an aspect ratio of at least about 100:1, at least about 200:1, at least about 300:1, at least about 400:1, or at least about 500:1, inclusive of all values and ranges therebetween.

In some embodiments, the GO sheets 110 can have a carbon to oxygen ratio (C:O) of at least about 1.0:1, at least about 1.1:1, at least about 1.2:1, at least about 1.3:1, at least about 1.4:1, at least about 1.5:1, at least about 1.6:1, at least about 1.7:1, at least about 1.8:1, at least about 1.9:1, at least about 2.0:1, at least about 2.2:1, at least about 2.4:1, at least about 2.6:1, at least about 2.8:1, or at least about 3.0:1, inclusive of all values and ranges therebetween.

In some embodiments, the polymer-modified graphene oxide membrane 100 can include at least about 100 layers of GO sheets 110, at least about 125 layers, at least about 150 layers, at least about 200 layers, at least about 225 layers, or at least about 250 layers, inclusive of all values and ranges therebetween. In some embodiments, the polymer-modified graphene oxide membrane 100 can include no more than about 600 layers of GO sheets 110, no more than about 550 layers, no more than about 500 layers, no more than about 450 layers, no more than about 400 layers, no more than about 350 layers, or no more than about 300 layers, inclusive of all values and ranges therebetween.

Combinations of the above-referenced ranges for the number of layers of GO sheets 110 in the polymer-modified graphene oxide membrane 100 are also possible (e.g., at least about 100 to less than about 600, or at least about 300 to less than about 600), inclusive of all values and ranges therebetween.

In some embodiments, the polymer-modified graphene oxide membrane 100 can include about 100 to 600 layers of GO sheets 110, e.g., 200-500 layers, 200-400 layers, 200-300 layers, 200-250 layers, 300-600 layers, 300-500 layers, or 300-400 layers.

FIG. 1B shows the GO sheets 110 can be coupled to a polymeric component 120 via one or more chemical and/or physical interactions. In some embodiments, the GO sheets 110 can be coupled to the polymeric component 120 via chemical interactions, and/or chemical reactions that form covalent bonds (e.g., covalent interactions). For example, in some embodiments, the polymeric component 120 can form covalent bonds with oxygen-containing functional groups on the GO sheets 110 such as epoxide groups, carboxylic groups, or hydroxyl groups. In some embodiments, the polymeric component 120 can form covalent bonds with non-oxygen containing groups on the GO sheets 110. In some embodiments, the polymeric component 120 can form covalent bonds with carbon atoms on the GO sheets 110. The structure of the polymer-modified graphene oxide membrane 110 can be such that the GO sheets 110 form one or more covalent bonds attaching the GO sheets 110 to the polymeric component 120. More specifically, as shown schematically in FIG. 1B, the structure of the polymer-modified graphene oxide membrane 100 can be such that a GO sheet 110 may include a covalent bond coupling the GO sheet 110 to a single polymeric component 120 molecule. It is also possible that a GO sheet 110 includes multiple covalent bonds linking the GO sheet 110 to either a single polymeric component 120 molecule (e.g., one GO sheet 110 attached to one polymeric component 120 molecule via multiple covalent bonds), or to multiple polymeric components 120 (e.g., one GO sheet 110 attached to two or more distinct polymeric components 120 molecules via one or more covalent bonds). It is also possible that multiple GO sheets 110 include covalent bonds that are attached to a single polymeric component 120 molecule (e.g., multiple GO sheets 110 attached to one single polymeric component 120 molecule). Alternatively, in some embodiments the GO sheets 110 can be coupled to the polymeric component 120 via physical and/or noncovalent interactions. For example, in some embodiments the polymeric component 120 can be coupled to one or more GO sheets 110 through ionic interactions. In some embodiments, the polymeric component 120 can be coupled to one or more GO sheets 110 through hydrogen bonding. In some embodiments, the polymeric component 120 can be coupled to the GO sheets 110 through one or more Van der Waals forces. In some embodiments, the polymeric component 120 can be coupled to the GO sheets 110 through one or more π-effects. In some embodiments, the polymeric component 120 can be coupled to the GO sheets 110 through the hydrophobic effect. In some embodiments, the GO sheets 110 can be coupled to the polymeric component 120 via covalent interactions and physical and/or noncovalent interactions (e.g., a combination of covalent interactions and non-covalent interactions). The coupling of the polymeric component 120 and the GO sheets 110 via covalent and/or non-covalent interactions can result in the formation of a polymer-modified graphene oxide membrane 110 in which the polymeric component 120 is disposed intercalated between GO sheets 110. For example, as shown in FIG. 1B, two adjacent GO sheets 110a can be coupled to a polymeric component 120a such that the polymeric component 120a is disposed intercalated between the two adjacent GO sheets 110a.

The polymer component 120 can be any suitable polymeric material having functional groups that can form covalent bonds with the GO sheets 110. The polymer component 120 can be coupled to the GO sheets 110 and disposed between the GO sheets 110 with the purpose of increasing and/or adjusting the d-spacing (e.g., interlayer spacing or intralayer spacing) of the GO sheets 110, as shown in FIG. 1B. In some embodiments, the polymer component 120 can be a polymeric material having amine functional groups. For example, in some embodiments the polymer component 120 can be and/or include polyethyleneimine (PEI). In other embodiments, the polymer component 120 can be and/or include poly(allylamine), polylysine, poly (Methacryloyl-L-Lysine), poly (R-allylamine) (where R can be methyl, ethyl, propyl, or butyl), poly(amidoamine) (PAMAM) dendrimers, aminated norbornenes, or a combination thereof. In some embodiments the polymer component 120 can be and/or include Polyvinylpyrrolidone (PVP), poly (3-Phenoxy 2 hydroxy propyl methacrylate) (PHPH), and/or Poly(4-vinylpyridine), or a combination thereof.

In some embodiments, the polymer component 120 can be and/or include

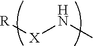

where R=O, N, and X=2-6 carbon atoms.

In some embodiments, the polymer component 120 can be and/or include

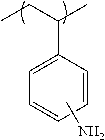

In some embodiments, the polymer component 120 can be and/or include

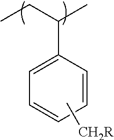

where R=OH, NH₂.

In some embodiments, the polymer component 120 can be and/or include

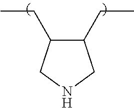

In some embodiments, the polymer component 120 can be and/or include

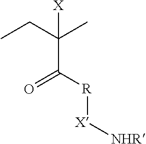

where X=0-1 carbon atoms; R=O, N; X′=2-5 carbon atoms, and R′=0-5 carbon atoms.

In some embodiments, the polymer component 120 can be and/or include

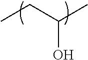

In some embodiments, the polymer component 120 can be and/or include

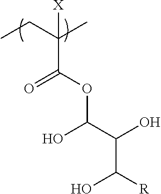

where X=0-1 carbon atoms; and R=OH, NH₂.

In some embodiments, the polymer component 120 can be and/or include

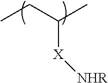

where X=0-3 carbon atoms, and R=0-4 carbon atoms.

In some embodiments, the polymer component 120 can be a co-polymer having a first polymeric material and a second polymeric material, wherein the first and the second polymeric material are selected from the polymer components described above. For example, in some embodiments, the polymer component 120 can be and/or include a polyethyleneimine (PEI)-polylysine copolymer. In some embodiments, polymer component 120 can be and/or include an aminated norbornene-Polyvinylpyrrolidone (PVP) copolymer.

In some embodiments polymer component 120 can have an average molecular weight of at least about 1 kDa, at least about 1.5 kDa, at least about 2 kDa, at least about 3 kDa, at least about 4 kDa, at least about 5 kDa, at least about 6 kDa, at least about 8 kDa, at least about 10 kDa, at least about 15 kDa, at least about 20 kDa, at least about 25 kDa, at least about 30 kDa, at least about 40 kDa, at least about 45 kDa, at least about 50 kDa, at least about 55 kDa, at least about 60 kDa, at least about 65 kDa, or at least about 70 kDa, inclusive of all values and ranges therebetween. In some embodiments polymer component 120 can have an average molecular weight of no more than about 70 kDa, no more than about 66 kDa, no more than about 62 kDa, no more than about 58 kDa, no more than about 54 kDa, no more than about 50 kDa, no more than about 36 kDa, no more than about 32 kDa, no more than about 28 kDa, no more than about 24 kDa, no more than about 20 kDa, no more than about 16 kDa, no more than about 12 kDa, no more than about 8 kDa, no more than about 6 kDa, no more than about 4 kDa, no more than about 2 kDa, or no more than about 1 kDa, inclusive of all values and ranges therebetween.

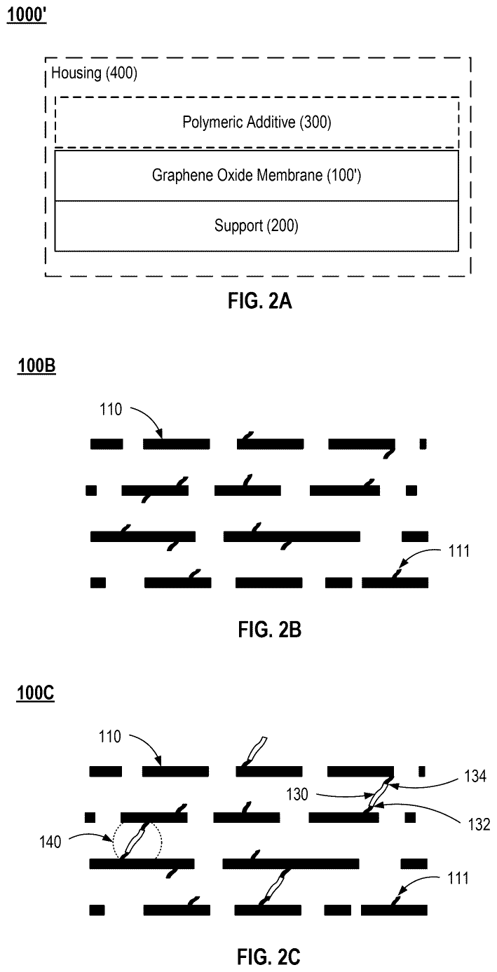

FIG. 2A shows a schematic illustration of a filtration apparatus 1000′ according to some embodiments of the present disclosure. The filtration apparatus 1000′ includes a graphene oxide membrane 100′, a support 200, a polymeric additive 300, and optionally a housing 400. The graphene oxide membrane 100′ can be disposed on the support 200, and the polymeric additive 300 can be disposed on the graphene oxide membrane 100′. The housing 400 can enclose the support 200, the graphene oxide membrane 100′, and polymeric additive 300.

In some embodiments, the graphene oxide membrane 100′, the polymeric additive 300, and the support 200 can have a combined thickness of about 50 μm to about 1300 μm, about 100 μm to about 750 μm, about 200 μm to about 1000 μm, or about 200 μm to about 1200 μm, inclusive of all values and ranges therebetween.

In some embodiments, the filtration apparatus 1000′ includes about 0.1 mg to 6 mg of the graphene oxide membrane 100′ per 5000 mm². In some embodiments, the filtration apparatus 1000′ includes about 0.1 mg to 5 mg, about 0.1 mg to 4 mg, about 0.1 mg to 3 mg, about 0.5 mg to 5 mg, about 0.5 mg to 4 mg, about 0.5 mg to 3 mg, about 1 mg to 4 mg, or about 1 mg to 3 mg of the graphene oxide membrane 100′ per 5000 mm². For example, the filtration apparatus 1000′ can include about 1 mg, about 1.5 mg, about 2 mg, about 2.5 mg, or about 3 mg of the graphene oxide membrane 100′ per 5000 mm².

The filtration apparatus 1000′ can include components and/or portions that are similar to and/or the same as components and/or portions of the filtration apparatus 1000 described above with reference to FIG. 1A. Consequently, components and/or portions of the filtration apparatus 1000′ shown in FIG. 2A that are similar to and/or the same as components and/or portions of the filtration apparatus 1000 (e.g., the support 200 and/or the housing 400) are not described in further detail herein.

FIGS. 2B and 2C show a diagram of the structure of two example graphene oxide membranes 100′ (e.g., membranes 100B and 100C) according to embodiments of the present disclosure. FIG. 2B shows a graphene oxide membrane 100B including a plurality of graphene oxide (GO) sheets 110 and a plurality of chemical spacers 111. Each of the GO sheets 110 in FIG. 2B is not covalently crosslinked to the adjacent GO sheet 110. FIG. 2C shows a graphene oxide membrane 100C including a plurality of GO sheets 110 and a plurality of chemical spacers 111. The GO sheets 110 in FIG. 2C can optionally be coupled to an adjacent GO sheet 110 via at least one chemical linker 130, wherein the chemical linker 130 is covalently coupled to the chemical spacer 111 on each GO sheet 110. More specifically, the chemical linker 130 can have at least two ends that are coupled to adjacent GO sheets 110. As shown in FIG. 2C, the chemical linker 130 can include a first end 132 coupled to a first chemical spacer 111 on a first GO sheet 110 and a second end 134 coupled to a second chemical spacer 111 on a second GO sheet 110. The combination of the chemical spacer 111 and the chemical linker 130 that is coupled thereto can be referred to as crosslinker 140, as further described herein.

The GO sheets 110 shown in FIGS. 2B and 2C can be arranged and/or oriented generally parallel to each other forming one or more stacked layers. The spacing (e.g., d-spacing) between GO sheets 110 can be either interlayer spacing or intralayer spacing. The spacing between the GO sheet 110 can be engineered to control the molecular weight cutoff and the flux properties of the polymer-modified graphene oxide membrane 100′, as further described herein.

In some embodiments, the graphene oxide membrane 100′ can include at least about 100 layers of GO sheets 110, at least about 125 layers, at least about 150 layers, at least about 200 layers, at least about 225 layers, at least about 250 layers of graphene sheets, inclusive of all values and ranges therebetween. In some embodiments, the graphene oxide membrane 100′ can include no more than about 600 layers of GO sheets 110, no more than about 550 layers, no more than about 500 layers, no more than about 450 layers, no more than about 400 layers, no more than about 350 layers, or no more than about 300 layers of GO sheets 110, inclusive of all values and ranges therebetween.

Combinations of the above-referenced ranges for the number of layers of GO sheets 110 in the graphene oxide membrane 100′ are also possible (e.g., at least about 100 to less than about 600, or at least about 300 to less than about 600), inclusive of all values and ranges therebetween.

In some embodiments, the graphene oxide membrane 100′ can include about 100 to 600 layers of GO sheets 110, e.g., 200-500 layers, 200-400 layers, 200-300 layers, 200-250 layers, 300-600 layers, 300-500 layers, or 300-400 layers.

In some embodiments, the graphene oxide membrane 100′ can have a thickness greater than or equal to about 25 nm, greater than or equal to about 50 nm, greater than or equal to about 0.1 microns, greater than or equal to about 0.15 microns, greater than or equal to about 0.2 microns, greater than or equal to about 0.3 microns, greater than or equal to about 0.4 microns, greater than or equal to about 0.5 microns, greater man or equal to about 0.75 microns, greater than or equal to about 1 micron, greater than or equal to about 2 microns. In some embodiments, the thickness of the graphene oxide membrane 100′ may be less than or equal to about 5 microns, less than or equal to about 1 micron, less than or equal to about 0.75 microns, less than or equal to about 0.5 microns

Combinations of the above-referenced ranges for the thickness of the graphene oxide membrane 100′ are also possible (e.g., greater than or equal to about 25 nm to less than or equal to about 5 microns, greater than or equal to about 0.15 microns to less than or equal to about 0.5 microns).

In some embodiments, the graphene oxide membrane 100′ can have an average pore size of greater than or equal to about 0.5 nm, greater than or equal to about 1 nm, greater than or equal to about 2 nm, greater than or equal to about 3 nm, greater than or equal to about 4 nm, or greater than or equal to about 5 nm. In some embodiments, the graphene oxide membrane 100′ can have an average pore size of less than or equal to about 6 nm, less than or equal to about 5 nm, less than or equal to about 4 nm, less than or equal to about 3 nm, or less than or equal to about 2 nm, inclusive of all values and ranges therebetween.

Combination of the above-referenced ranges for the average pore size are also possible (e.g., greater than or equal to about 0.5 nm to less than or equal to about 6 nm, greater than or equal to about 1 nm to less than or equal to about 6 nm). In some embodiments, the graphene oxide membrane 100′ can have an average pore size of about 0.5 nm, about 0.8 nm, about 1 nm, about 2 nm, about 3 nm, about 4 nm, about 5 nm, or about 6 nm.

In some embodiments, the chemical spacer 111 can form a covalent bond with an oxygen-containing functional group on the GO sheet 110. For example, the chemical spacer 111 can form a covalent bond with the epoxide groups, carboxylic groups or hydroxyl groups on the graphene oxide. In some embodiments, the chemical spacer 111 can also form a covalent bond with a non-oxygen-containing group (e.g., amine) on the GO sheet 110.

In some embodiments, the chemical spacer 111 can form a noncovalent interaction with an adjacent GO sheet 110 through a variety of mechanisms. In some embodiments, the chemical spacer 111 can be coupled to the adjacent GO sheet 110 through an ionic interaction. In some embodiments, the chemical spacer 111 can be coupled to the adjacent GO sheet 110 through hydrogen bonding. In some embodiments, the chemical spacer 111 can be coupled to the adjacent GO sheet 110 through one or more Van der Waals forces. In some embodiments, the chemical spacer 111 can be coupled to the adjacent GO sheet 110 through one or more 71-effects. In some embodiments, the chemical spacer 111 can be coupled to the adjacent GO sheet 110 through the hydrophobic effect.

In some embodiments, the chemical spacer 111 can include an amine or a derivative thereof. In some embodiments, the chemical spacer 111 can have the structure in accordance with Formula I:

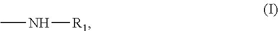

wherein: R₁ is an aryl or heteroaryl, which can be optionally substituted. In some embodiments, R₁ is

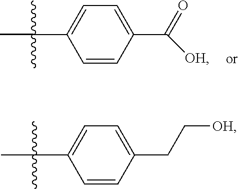 [SMILES: *c1ccc(C(=O)O)cc1 ; *c1ccc(CCO)cc1]

where [symbol] denotes the point of coupling with —NH.

In some embodiments, the chemical spacer 111 can include 4-aminophenylacetic acid, 2-(4-aminophenyl) ethanol, 2-(4-aminophenyl) propanol, 2-(4-aminophenyl) butanol, or any combination thereof.

In some embodiments, the chemical spacer 111 can include an amide or a derivative thereof. In some embodiments, the chemical spacer 111 can include the structure in accordance with Formula II:

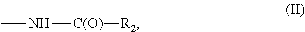

wherein: R₂ is a C₁-C₁₀ alkyl or a C₂-C₁₀ alkenyl, each of which can be optionally substituted. In some embodiments, R₂ is a C₁-C₈ alkyl, C₁-C₆ alkyl, C₂-C₈ alkenyl, or C₂-C₆ alkenyl. In some embodiments, non-limiting examples of R₂ can include methyl, ethyl, n-propyl, isopropyl, n-butyl, isobutyl, sec-butyl, tert-butyl, pentyl, hexyl, heptyl, octyl, nonyl, decyl, ethenyl, propenyl, and butenyl.

In some embodiments, the chemical spacer 111 can include acrylamide, propionamide, isobutyramide, pivalamide, or any combination thereof.

In some embodiments, the chemical spacer 111 can include a carbamate or a derivative thereof. In some embodiments, the chemical spacer 111 can include the structure in accordance with Formula IIa:

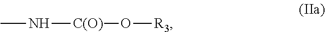

wherein: R₃ is a C₁-C₁₀ alkyl, a C₂-C₁₀ alkenyl, C₄-C₁₀ heterocycloalkyl, C₄-C₁₀ cycloalkyl, alkylaryl, aryl, or heteroaryl, each of which can be optionally substituted. In some embodiments, R₃ is a C₁-C₈ alkyl, C₁-C₆ alkyl, C₂-C₈ alkenyl, C₂-C₆ alkenyl, phenyl, or methylphenyl. In some embodiments, R₃ is methyl, ethyl, n-propyl, isopropyl, n-butyl, isobutyl, sec-butyl, tert-butyl, pentyl, hexyl, heptyl, octyl, nonyl, decyl, ethenyl, propenyl, or butenyl.

In some embodiments, non-limiting examples of the chemical spacer 111 can include methyl carbamate, ethyl carbamate, propyl carbamate, butyl carbamate, tert-butyl carbamate, phenyl carbamate, and benzyl carbamate.

In some embodiments, the weight ratio of GO sheets 110 to chemical spacer 111 in the graphene oxide membrane 100′ can be less than about 1,000, less than about 500, less than about 400, less than about 300, less than about 200, less than about 100, less than about 50, less than about 25, less than about 15, less than about 10, or less than about 5, inclusive of all values and ranges therebetween. In some embodiments, the weight ratio of GO sheets 110 to chemical spacer 111 in the graphene oxide membrane 100′ can be at least about 5, at least about 10, at least about 15, at least about 20, at least about 25, at least about 30, at least about 35, at least about 40, at least about 45, or at least about 50, inclusive of all values and ranges therebetween.

Combinations of the above-referenced ranges for the weight ratio are also possible (e.g., at least about 5 to less than about 1000, or at least about 10 to less than about 200).

In some embodiments, the atomic percent (at %) content of nitrogen present on the surface of the graphene oxide membrane 100′ measured by X-Ray photoelectron Spectroscopy can be less than about 5.0 at %, less than about 4.5 at %, less than about 4.0 at %, less than about 3.5 at %, less than about 3.2 at %, less than about 3.0 at %, less than about 2.8 at %, less than about 2.6 at %, less than about 2.4 at %, less than about 2.2 at %, less than about 2.0 at %, inclusive of all values and ranges therebetween. In some embodiments, the atomic percent (at %) content of nitrogen present on the surface of the graphene oxide membrane 100′ measured by X-Ray photoelectron Spectroscopy can be at least about 0.6 at %, at least about 1.1 at %, at least about 1.2 at %, at least about 1.3 at %, at least about 1.4 at %, at least about 1.5 at %, at least about 1.6 at %, at least about 1.8 at %, at least about 2.0 at %, inclusive of all values and ranges therebetween.

Combinations of the above referenced ranges for the at % content of nitrogen are also possible (e.g., at least about 0.6 at % to less than about 5.0 at %, or at least about 1.1 at % to less than about 3.2 at %).

In some embodiments, the atomic percent (at %) content of carbon present on the surface of the graphene oxide membrane 100′ measured by X-Ray photoelectron Spectroscopy can be less than about 80%, less than about 78%, less than about 75%, inclusive of all values and ranges therebetween. In some embodiments, the at % content of carbon present on the surface of the graphene oxide membrane 100′ measured by X-Ray photoelectron Spectroscopy can be at least about 50%, at least about 55%, or at least about 60%, inclusive of all values and ranges therebetween.

Combinations of the above referenced ranges for the at % content of carbon are also possible (e.g., at least about 50% to less than about 80%, or at least about 60% to less than about 75%). In contrast, existing graphene oxide membranes that are deliberately or unintentionally reduced often have at % content of carbon greater than 80% or even greater than 95%.

As described above with reference to FIG. 2C, in some embodiments the GO sheets 110 can optionally be coupled to an adjacent GO sheet 110 via at least one chemical linker 130. In some embodiments, the GO sheets 110 can be arranged and oriented generally parallel to each other and each of the GO sheets 110 can be coupled to an adjacent GO sheet 110 via a chemical linker 130.

The chemical linker 130 can be either linear or branched. In some embodiments, the chemical linkers 130 coupling adjacent GO sheets 110 can include a combination of linear and branched structures. In some embodiments, the length of the chemical linker 130 may be selected to impart desirable properties and/or control the spacing between the GO sheets 110. The spacing between the GO sheets 110 can be either interlayer spacing or intralayer spacing. The spacing between the GO sheets 110 can be engineered to control the molecular weight cutoff of the graphene oxide membrane 100′.

The chemical linker 130 can have at least two ends that are coupled to adjacent GO sheets 110. For example, as shown in FIG. 2C, the chemical linker can include a first end 132 coupled to a first chemical spacer 111 on a first GO sheet 110 and a second end 134 coupled to a second chemical spacer 111 on a second GO sheet 110. The first end 132 can be coupled to the first chemical spacer 111 through a covalent bond or a noncovalent interaction. The second end 134 can be coupled to the second chemical spacer 111 through a covalent bond or a noncovalent interaction. In some embodiments, an end of the chemical linker 130 (e.g., the first end 132, the second end 134, or another end) may be dangling, i.e., not coupled to anything.

In some embodiments, the chemical linker 130 can form a covalent bond with the oxygen-containing functional groups on the chemical spacer 111. For example, the chemical linker 130 can form a covalent bond with an epoxide group, a carboxylic group, or a hydroxyl group on the chemical spacer 111. In some embodiments, the chemical linker 130 can also form a covalent bond with a non-oxygen-containing group (e.g., amine) on the chemical space 111. In some embodiments, the chemical linker 130 can also form a covalent bond with a carbon atom on the chemical spacer 111.

The combination of the chemical spacer 111 and the chemical linker 130 that is coupled thereto is referred to herein as the crosslinker 140.

In some embodiments, the crosslinker 140 can have a structure in accordance with Formula III:

R₄-A-R₅ (III)
wherein: A is absent, aryl, heteroaryl, C₁-C₁₀ alkylene linker, C₂-C₁₀ alkenylene linker, or (—CH₂—CH₂—O—)ₚ (p=1 to 5), each of which can be optionally substituted; and
R₄ and R₅ are independently selected from C₁-C₁₀ alkyl, C₁-C₁₀ alkenyl, C₁-C₁₀ hydroxyalkyl, —C₀-C₆ alkyl-C(O)—O—C₀-C₆ alkyl, —C(O)—O—C₁-C₁₀ alkyl, —C₀-C₆ alkyl-C(O)—S—C₀-C₆ alkyl, —C(O)—S—C₁-C₁₀ alkyl, —C₀-C₆ alkyl-O—C₀-C₆ alkyl, —O—C₁-C₁₀ alkyl, —C₀-C₆ alkyl-S—C₀-C₆ alkyl, —S—C₁-C₁₀ alkyl, —C₀-C₆ alkyl-NH—C₀-C₆ alkyl, —NH—, —NH—(C₁-C₁₀ alkyl)₂, —NH—C₁-C₁₀ alkyl, —C₀-C₆ alkyl-NH—C(O)—C₀-C₆ alkyl, —NH—C(O)—C₁-C₁₀ alkyl, and (—CH₂—CH₂—O—)ₚ (p=1 to 5), each of which can be optionally substituted, wherein one end of each of R₄ and R₅ can be optionally coupled to a GO sheet 110. In some embodiments, the alkyl, alkenyl, or hydroxyalkyl in R₄ and/or R₅ can be optionally coupled to a GO sheet 110. In some embodiments, A is phenyl, biphenyl, naphthyl, or

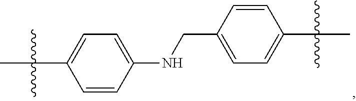 [SMILES: *c1ccc(CNc2ccc(*)cc2)cc1]

where [symbol] denotes the point of coupling with R₄ or R₅.

In some embodiments, A is a C1-C6 alkylene linker or a C2-C6 alkenylene linker, each of which can be optionally substituted.

In some embodiments, A is absent.

In some embodiments, R₄ and R₅ independently includes an ether, amine, amide, thioether, or a combination thereof.

In some embodiments, R₄ and R₅ are independently selected from —(CH₂)₁₋₁₀O—, —(CH₂)₁₋₁₀OC(O)—, —(CH₂)₀₋₆—NH—C(O)—(CH₂)₀₋₆—, —(CH₂)₀₋₆—O—(CH₂)₀₋₆—, —(CH₂)₀₋₆—S—(CH₂)₀₋₆—, or —NH—, each of which can be optionally substituted

In some embodiments, R₄ and R₅ are independently C₁-C₁₀ hydroxyalkyl, which can be optionally substituted, and the hydroxyalkyl can be optionally coupled to a GO sheet 110.

In some embodiments, R₄ and R₅ are independently —NH—, —NH—C(O)—, —NH—C(O)—(CH₂)₂—O—, —CH₂—NH-phenyl-HN—C(O)—, —CH₂—S—(CH₂)₂—NH—C(O)—, or —CH₂—O—C(O)—.

In some embodiments, R₄ and R₅ are independently —NH—C(O)—C₁-C₁₀ alkyl, which can be optionally substituted, and the alkyl can be optionally coupled to a GO sheet 110. For example, R₄ and R₅ can be independently —NH—C(O)—(CH₂)_{q}—O— (q=1 to 10).

In some embodiments, the crosslinker 140 can have a structure in accordance with Formula IIIa:

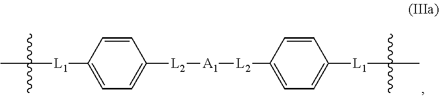

wherein:
L₁ is selected from —NH—, —C(═O)—NH—, or absent;
L₂ is selected from absent, —C(═O)—NH—(CH₂)ₙ—, —(CH₂)₂—O—(CH₂)ₙ—, or —NH—(CH₂)ₙ—;
A₁ is selected from absent, aryl, heteroaryl, C₄-C₁₀ heterocycloalkyl, C₄-C₁₀ cycloalkyl, or C₄-C₁₀ alkyl, wherein the aryl, heteroaryl, heterocycloalkyl, cycloalkyl, and alkyl can each be optionally substituted by one or more substituents selected from halo, C₁-C₄ alkoxy, or C₁-C₄ alkyl;
n is 0-4; and
[symbol] denotes the point of coupling with a carbon atom on a GO sheet 110.

In some embodiments, A₁ is phenyl. For example, the crosslinker 140 can have a structure in accordance with Formula IIIa-1:

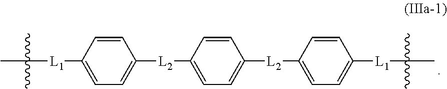

In some embodiments, A₁ is linear C₅ alkyl. In some embodiments, A₁ is linear C₆ alkyl.

In some embodiments, n is 0. In some embodiments, n is 1. In some embodiments, n is 2. In some embodiments, n is 3. In some embodiments, n is 4.

In some embodiments, the crosslinker 140 can have a structure in accordance with Formula IIIb:

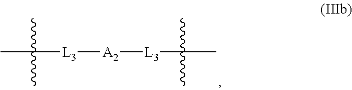

wherein:
L₃ is selected from —C(═O)—NH—(CH₂)ₘ—, —C(═O)—NH—C(═O)—(CH₃)₂—S—(CH₂)ₘ—, or —NH—C(═O)—(CH₃)₂—S—(CH₂)ₘ—;
A₂ is selected from aryl, heteroaryl, C₄-C₁₀ heterocycloalkyl, C₄-C₁₀ cycloalkyl, or C₄-C₁₀ alkyl, wherein the aryl, heteroaryl, heterocycloalkyl, cycloalkyl, and alkyl can each be optionally substituted by one or more substituents selected from halo, C₁-C₄ alkoxy, or C₁-C₄ alkyl;
m is 0-4; and
[symbol] denotes the point of coupling with a carbon atom on a GO sheet 110.

In some embodiments, A₂ is phenyl. For example, the crosslinker 140 can have a structure in accordance with Formula IIIb-1:

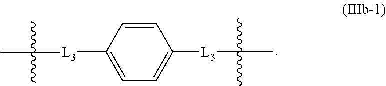

In some embodiments, A₂ is linear C₅ alkyl. In some embodiments, A₂ is linear C₆ alkyl.

In some embodiments, m is 0. In some embodiments, m is 1. In some embodiments, m is 2. In some embodiments, m is 3. In some embodiments, m is 4.

In some embodiments, the crosslinker 140 can have one of the following structures:

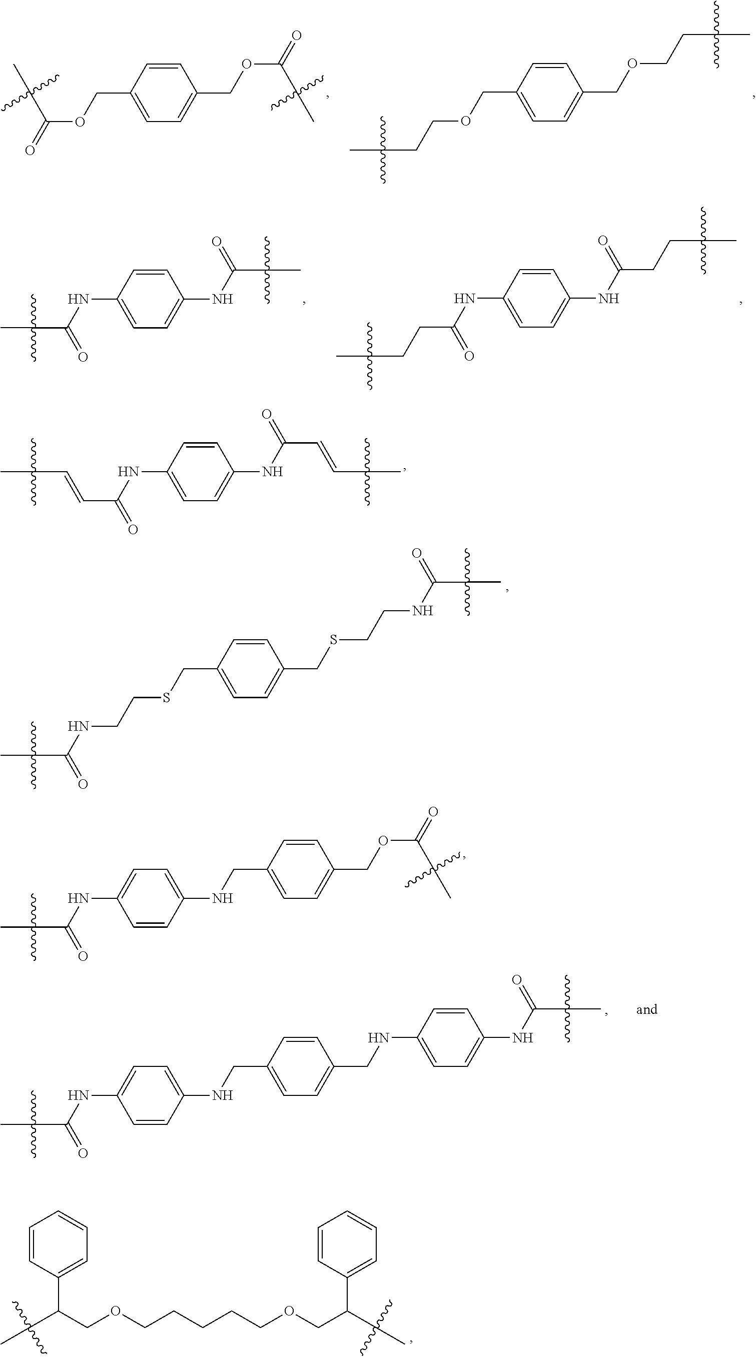

where [symbol] denotes the point of coupling with a GO sheet 110. Each of these crosslinkers can be optionally substituted.

In some embodiments, the chemical linker 130 can have one of the following structures:

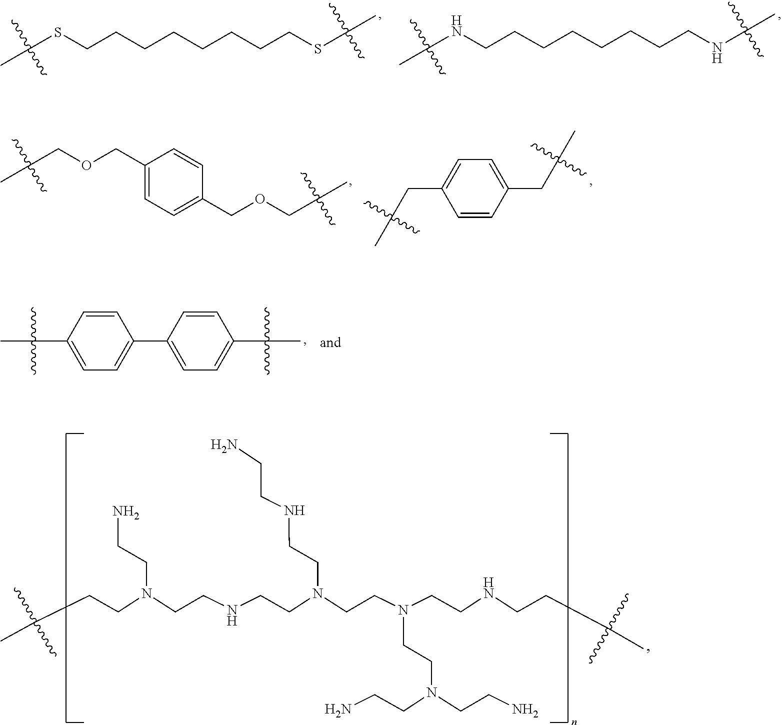

where: n is 1 to 5; [symbol] denotes the point of coupling to the chemical spacer 111.

Swelling of membranes can be problematic because it can adversely affect the structural integrity of the membrane, change the molecular weight cutoff, etc. Without being bound by any particular theory, it is believed that the interaction (e.g., van der Waals interactions) between the GO sheets 110 are relatively weak and certain solvents and/or solvents at certain temperatures enter into the region between the sheets and disrupt some of these interactions resulting in swelling and/or destabilization. The crosslinkers 140 may serve to stabilize the graphene oxide membrane 100′ from destabilization in solvents and/or at elevated temperatures. In some embodiments, the crosslinker 140 may have a length and/or density that substantially reduces swelling of the graphene oxide membrane 100′ in certain environments (e.g., solvents, elevated temperatures, etc.) and/or prevents destabilization of the graphene oxide membrane 100′.

In some embodiments, the weight ratio of graphene oxide to crosslinker 140 in the finished membrane can be less than about 1,000, less than about 500, less than about 400, less than about 300, less than about 200, less than about 100, less than about 50, less than about 25, less than about 15, less than about 10, or less than about 5, inclusive of all values and ranges therebetween. In some embodiments, the weight ratio of graphene oxide to crosslinker 140 in the finished membrane can be at least about 5, at least about 10, at least about 15, at least about 20, at least about 25, at least about 30, at least about 35, at least about 40, at least about 45, or at least about 50, inclusive of all values and ranges therebetween.

Combinations of the above-referenced ranges for the weight ratio are also possible (e.g., at least about 5 to less than about 1000, or at least about 10 to less than about 200).

Some embodiments of the graphene oxide membrane 100′ can be similar to and/or the same as the graphene oxide membraned disclosed in U.S. Pat. No. 11,123,694, titled, “Filtration Apparatus Containing Graphene Oxide membrane,” issued Sep. 21, 2021 (“the '694 patent”), and U.S. Pat. No. 11,097,227, titled, “Durable Graphene Oxide Membranes,” issued Aug. 24, 2021 (“the '227 patent”); the contents of each of which are incorporated herein by reference.

The polymeric additive 300 on the graphene oxide membrane 100′ can act as a protective layer that prevents damage of the graphene oxide membrane 100′ and other components of the filtration apparatus 1000′. For example, the polymeric additive 300 can protect the GO sheets 110 from damage (e.g., formation of pinholes, punctures, cracks, or other mechanical stress-induce defects) resulting from the fabrication of spiral membranes. Consequently, suitable candidates for the polymeric additive 300 include polymers can be casted into continuous layers or coatings with robust mechanical properties including as high Young's modulus, hardness, scratch resistance, and/or self-healing properties. The polymeric additive 300 should also be water soluble. The water solubility of the polymeric additive 300 facilitates the use of the filtration apparatus 1000′ in a wide range of industrial applications including but not limited to food processing, pharmaceuticals, paint, textiles, paper, construction, adhesives, coatings, and/or water treatment.

In some embodiments, the polymeric additive 300 can comprise hydrophilic groups that may be nonionic, anionic, or cationic, such that the polymeric additive 300 can be dissolved, and/or dispersed in water. For example, in some embodiments, the polymeric additive 300 can be a water-soluble polymeric material such as poly (allyl amine), poly (allyl amine HCl), polyethylene glycol (PEG), hydroxypropyl methyl cellulose (HPMC), poly styrenesulfonate (PSS), polyacrylamide, and/or polyacrylamide dopamine. These polymers exhibit structural diversity: formal charges, chemical moieties, aliphatic, and aromatic.

In some embodiments, the polymeric additive 300 can include one or more components that facilitate formation of continuous films or coatings free of defects, preventing damage of the membrane 100′ during fabrication and/or operation. For example, in some embodiments, the polymeric additive 300 can include a plasticizer that imparts flexibility to the polymeric additive layer and reduces the formation of cracks and/or pin holes during fabrication. In some embodiments, the polymeric additive 300 can include one or more plasticizers such as 1,2,3-triacetoxypropane (triacetin), triethyl citrate (TEC), polyols, ethanolamine, and/or oligosaccharides.

In some embodiments, the polymeric additive 300 can include a lubricant to prevent agglomeration of the polymeric additive layer deposited over the graphene oxide membrane 100′ and/or the processing equipment used to fabricate the filtration apparatus 1000′. For example, in some embodiments, the polymeric additive 300 can include one or more lubricants such as alcohols and hydroxy stearic acid.

In some embodiments, the polymeric additive 300 can have a thickness of about 0.1 μm to about 15 μm, about 0.5 μm to about 15 μm, about 0.5 μm to about 10 μm.

In some embodiments, the average molecular weight of the polymeric additive 300 can be less than about 6,000,000, less than about 5,000,000, less than about 4,000,000, less than about 2,000,000, less than about 1,000,000, less than about 500,000, less than about 400,000, less than about 200,000, less than about 180,000, less than about 150,000, less than about 120,000, inclusive of all values and ranges therebetween. In some embodiments, the average molecular weight of polymeric additive 300 can be at least about 120,000, at least about 150,000, at least about 180,000, at least about 200,000, at least about 400,000, at least about 500,000, at least about 1,000,000, inclusive of all values and ranges therebetween.

Combinations of the above referenced ranges for the average molecular weight of the polymeric additive 300 are also possible (e.g., at least about 120,000 to less than about 200,000, or at least about 5,000,000 to no less than about 6,000,000).

In some embodiments, the polymeric additive 300 can be disposed on a graphene oxide membrane 100′ by preparing a mixture of polymeric additive 300 in a suitable solvent, and subsequently casting the resulting polymeric additive 300 mixture with a rod caster over the previously prepared graphene oxide membrane 100′, as further disclosed herein. In some embodiments the casting mixture can contain at least 0.5 wt %, at least 0.75 wt %, at least 1 wt %, at least 2 wt %, at least 2.5 wt %, at least 3.0 wt %, at least 4.0 wt %, at least 5.0 wt %, at least 10 wt %, at least 20 wt %, at least 30 wt %, at least 40 wt %, at least 50 wt % of the polymeric additive 300, inclusive of all values and ranges therebetween. In some embodiments, the casting solution can contain less than 50 wt %, less than 40 wt %, less than 30 wt %, less than 20 wt %, less than 10 wt %, less than 5.0 wt %, less than 4.0 wt %, less than 3.0 wt %, less than 2.5 wt %, less than 2.0 wt %, less than 1.0 wt %, less than 0.75 wt %, or less than 0.5 wt % of the polymeric additive 300, inclusive of all values and ranges therebetween.

Combinations of the above-referenced ranges for the content of polymeric additive 300 present in the casting solution disposed on the graphene oxide membrane 100′ are also possible (e.g., at least about 0.5 wt % to less than about 50 wt %, or at least about 1.0 wt % to less than about 30 wt %), inclusive of all values and ranges therebetween.

The way in which the polymeric additive 300 is deposited strongly influences the observed rejection rate difference. Polymeric additives 300 can be incorporated in three distinct ways: undercoats, overcoats, and in the graphene oxide formulation. For undercoats, a layer of polymeric additive 300 is casted onto a support 200 and a graphene oxide membrane 100′ is deposited on top of the polymeric additive 300. In general, the polymeric additive 300 undercoats lead to uneven graphene oxide coatings which afforded membranes that exhibit poor rejection rates. For overcoats, a layer of polymeric additive 300 is casted on top of a graphene oxide membrane 100′. Polymer additive 300 overcoats lead to salt rejection rates being on average at least about 20% lower than small molecule rejection rates.

In some embodiments, the polymeric additive 300 can be incorporated to the graphene oxide membrane 100′ during the fabrication process of the graphene oxide membrane 100′, and then the polymeric additive 300 and the graphene oxide membrane 100′ can be co-casted in a single step. In other words, the polymeric additive 300 can be pre-mixed with the graphene oxide membrane 100′ formulation and then casted simultaneously to produce the graphene oxide membrane 100′ with the polymeric additive 300, as further described herein.

The performance of the filtration apparatus 1000′ described herein with reference to FIGS. 2A-2C can be characterized by the rejection rates for specific species. The filtration apparatus 1000′ can have rejection rates with tunable selectivity for various small molecules, monovalent/divalent salts and/or ions, and other species. For example, in some instances, the rejection rates for a sugar molecule (e.g., lactose) can be high, while the rejection rate for a salt molecule (e.g., MgSO₄) can be lower. The sugar rejection rate of the filtration apparatus 1000′ can be decoupled from the salt rejection rate by judicious selection of polymeric additives, as further described herein.

In some embodiments, the sugar rejection rate is a lactose rejection rate which can be measured by flowing a 1 wt % lactose solution through the filtration apparatus 1000′, and then measuring the percentage of lactose being rejected by the filtration apparatus 1000′. In some embodiments, the salt rejection rate is a MgSO₄ rejection rate, which can be measured by flowing a 0.1 wt % MgSO₄ solution through the filtration apparatus 1000′, and then measuring the percentage of MgSO₄ being rejected by the filtration apparatus 1000′.

In some embodiments, the difference between the lactose rejection rate and the MgSO₄ rejection rate can be at least about 20%, at least about 25%, at least about 30%, at least about 35%, at least about 40%, at least about 45%, at least about 50%, or at least about 55%, inclusive of all values and ranges therebetween.

In some embodiments, the difference between the lactose rejection rate and the MgSO₄ rejection rate can be no more than about 60%, no more than about 55%, no more than about 50%, no more than about 45%, or no more than about 35% inclusive of all values and ranges therebetween.

Combinations of the above-referenced ranges for the difference are also possible (e.g., at least about 20% to no more than about 60%, or at least about 20% to no more than about 40%), inclusive of all values and ranges therebetween.

In some embodiments, the difference between the lactose rejection rate and the MgSO₄ rejection rate can be about 20%, about 25%, about 30%, about 35%, about 40%, about 45%, about 50%, or about 55%.

In some embodiments, the filtration apparatus 1000′ can have a lactose rejection rate of at least about 50%, at least about 55%, at least about 60%, at least about 65%, at least about 70%, at least about 75%, at least about 80%, at least about 85%, at least about 90%, at least about 95%, at least about 98%, or at least about 99%, with a 1 wt % lactose solution. The lactose rejection rate can be measured at room temperature.

In some embodiments, the filtration apparatus 1000′ can have a lactose rejection rate of about 50% to about 99.5% with a 1 wt % lactose solution. In some embodiments, the filtration apparatus 1000′ can have a lactose rejection rate of about 60% to about 99.5% with a 1 wt % lactose solution. In some embodiments, the filtration apparatus 1000′ can have a lactose rejection rate of about 70% to about 99.5% with a 1 wt % lactose solution. In some embodiments, filtration apparatus 1000′ can have a lactose rejection rate of about 80% to about 99.5% with a 1 wt % lactose solution. In some embodiments, the filtration apparatus 1000′ can have a lactose rejection rate of about 90% to about 99.5% with a 1 wt % lactose solution. In some embodiments, the filtration apparatus 1000′ can have a lactose rejection rate of about 95% to about 99.5% with a 1 wt % lactose solution.

In some embodiments, the filtration apparatus 1000′ can have a MgSO₄ rejection rate of at least about 30%, at least about 40%, at least about 50%, at least about 60%, at least about 65%, or at least about 70%, with a 0.1 wt % MgSO₄ solution. The MgSO₄ rejection rate can be measured at room temperature.

In some embodiments, the filtration apparatus 1000′ can have a MgSO₄ rejection rate of about 30% to about 80% with a 0.1 wt % MgSO₄ solution. In some embodiments, the filtration apparatus 1000′ can have a MgSO₄ rejection rate of about 40% to about 80% with a 0.1 wt % MgSO₄ solution. In some embodiments, the filtration apparatus 1000′ can have a MgSO₄ rejection rate of about 50% to about 80% with a 0.1 wt % MgSO₄ solution. In some embodiments, the filtration apparatus 1000′ can have a MgSO₄ rejection rate of about 30% to about 75% with a 0.1 wt % MgSO₄ solution. In some embodiments, the filtration apparatus 1000′ can have a MgSO₄ rejection rate of about 30% to about 70% with a 0.1 wt % MgSO₄ solution. In some embodiments, the filtration apparatus 1000′ can have a MgSO₄ rejection rate of about 40% to about 70% with a 0.1 wt % MgSO₄ solution. In some embodiments, the filtration apparatus 1000′ can have a MgSO₄ rejection rate of about 50% to about 70% with a 0.1 wt % MgSO₄ solution.

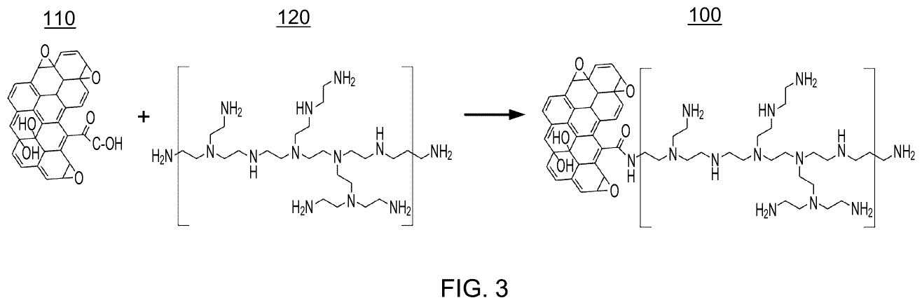

Referring back to the filtration apparatus 1000 comprising a polymer modified-graphene oxide membrane 100, FIG. 3 shows an example chemical reaction between a polyethyleneimine (PEI) polymer component 120 and the GO sheets 110 that produces a polyethyleneimine polymer-modified graphene oxide membrane 100, also referred to herein as a PEI-GO polymer-modified graphene oxide membrane 100. As shown in FIG. 3, the GO sheets 110 includes carboxylic acid functional groups that can react with amine groups present on the polyethyleneimine (PEI) polymer component 120, forming and/or producing thermally stable amide bonds that effectively couple the polyethyleneimine (PEI) polymer component 120 to the GO sheets 110. As described above, the structure of the PEI-GO polymer-modified graphene oxide membrane 100 can be such that a GO sheet 110 may include one amide bond coupling the GO sheet 110 to a single PEI polymeric component 120 molecule. It is also possible that a GO sheet 110 includes multiple amide bonds linking the GO sheet 110 to either a single PEI polymer component 120 molecule (e.g., one GO sheet 110 attached to one PEI polymeric component 120 molecule via multiple amide bonds), or to multiple polymer components 120 molecules (e.g., one GO sheet 110 attached to two or more distinct polymer components 120 molecules via multiple amide bonds). It is also possible that a plurality of GO sheets 110 include amide bonds that are attached to a single component 120 molecule (e.g., multiple GO sheets 110 attached to one single polymeric component 120 molecule via amide bonds).

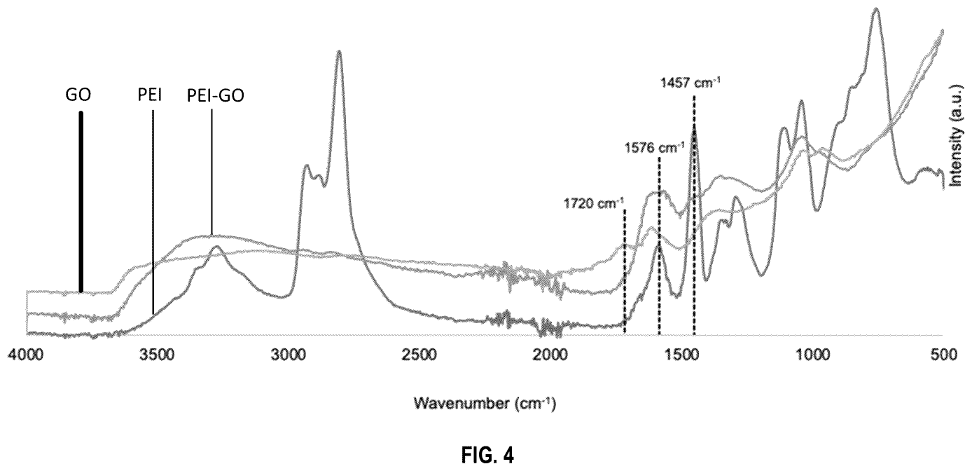

FIG. 4 shows Fourier Transformed Infrared (FTIR) Spectra of graphene oxide (GO), a PEI polymeric component 120 (PEI average molecular weight ˜25 kDa), and a 25 kDa PEI-GO polymer-modified graphene oxide membrane 100 prepared and/or produced according to an embodiment of the present disclosure. The 25 kDa PEI-GO polymer-modified graphene oxide membrane 100 has been prepared and/or produced by chemical reactions of the 25 kDa PEI polymeric component 120 with GO sheets 110 present in graphene oxide (GO), as described above with reference to FIG. 3. The FTIR spectrum of graphene oxide (GO) displays a band at 1720 cm⁻¹ associated with the carbonyl (C═O) stretching vibration of carboxylic acid functional groups present in the GO Sheets 110. The carbonyl (C═O) band at 1720 cm⁻¹ is absent (e.g., not present) in the FTIR spectrum of the 25 kDa PEI polymeric component 120, as well as in the FTIR spectrum of the 25 kDa PEI-GO polymer-modified graphene oxide membrane 100. The FTIR spectrum of the 25 kDa PEI-GO polymer-modified graphene oxide membrane 100 reveals the presence of two bands at 1576 cm⁻¹ and 1457 cm⁻¹ attributed and/or assigned to the asymmetric amide (HNC═O) stretching vibration and the (C—N) stretching vibration, respectively. The presence of these bands at 1576 cm⁻¹ and 1457 cm⁻¹ and the absence of the carbonyl (C═O) band at 1720 cm⁻¹ indicates that carboxylic acid functional groups in the GO sheets 110 have been reacted and/or consumed to produce the amide bonds, effectively coupling and/or incorporating the 25 kDa Polymeric component 120 to the GO sheets 110 and forming the 25 kDa PEI-GO polymer-modified graphene oxide membrane 100, according to the reaction scheme disclosed in FIG. 3.

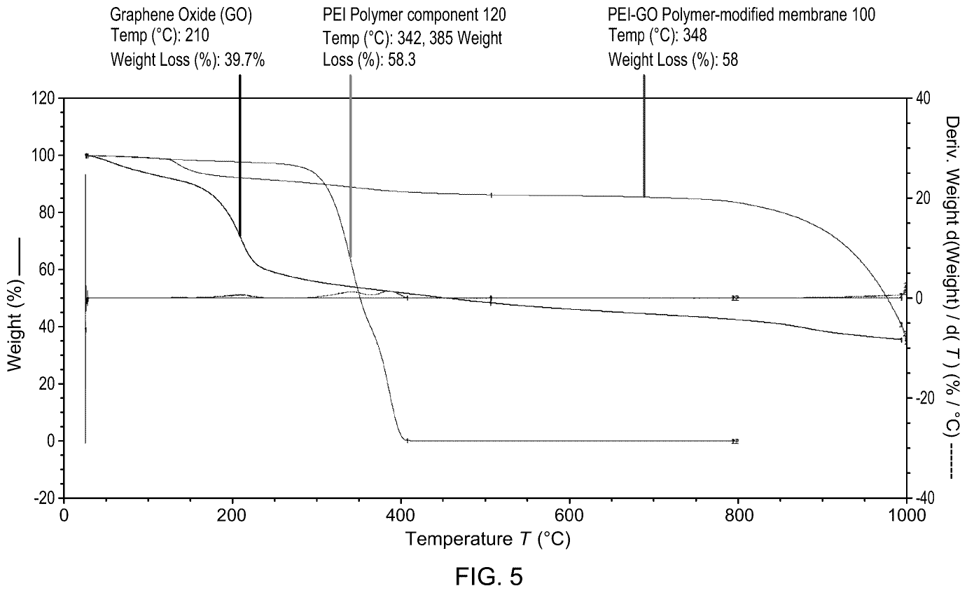

FIG. 5 shows example thermogravimetric analysis (TGA) curves of graphene oxide (GO), a PEI polymeric component 120 (PEI average molecular weight ˜25 kDa), and a 25 kDa (PEI-GO) polymer-modified graphene oxide membrane 100 prepared and/or produced according to an embodiment of the present disclosure. The 25 kDa PEI-GO polymer-modified graphene oxide membrane 100 has been prepared and/or produced by chemical reactions of the 25 kDa PEI polymeric component 120 with GO sheets 110 present in graphene oxide (GO), as described above with reference to FIG. 3. The TGA curve of Graphene Oxide (GO) reveals an initial inflection point at a temperature of 210° C. followed by a relatively flat profile with no major inflection points. In contrast, the TGA curve of the PEI polymeric component 120 shows two main inflection points at 342° C. and 385° C., associated with a loss of 58% and 40% of the total mass, respectively. The TGA curve of the 25 kDa PEI-GO polymer-modified graphene oxide membrane 100 shows an inflection point at a temperature of 348° C., associated with a loss of about 5.8% of the total mass. The similarity between the temperature inflection points of the PEI polymeric component 420 and the 25 kDa PEI-GO polymer-modified graphene oxide membrane 100 suggests that about a 5.8% of the total weight of the 25 kDa PEI-GO polymer-modified graphene oxide membrane 100 corresponds to PEI polymeric component 120 incorporated via the reaction scheme described in FIG. 3. In some embodiment, the percentage of PEI polymeric component 120 incorporated into a PEI-GO polymer-modified graphene oxide membrane 100 can be at least about 1.0%, at least about 1.5%, at least about 2.0%, at least about 2.5%, at least about 3.0%, at least about 4.0%, at least about 5.0%, at least about 6.0%, at least about 7.0%, at least about 8.0%, at least about 9.0%, at least about 10%, at least about 12%, at least about 14%, at least about 16%, at least about 18%, at least about 20%, at least about 22%, at least about 24%, or at least about 25%, inclusive of all values and ranges therebetween. In some embodiment, the percentage of PEI polymeric component 120 incorporated into a PEI-GO polymer-modified graphene oxide membrane 100 can be no more than about 25%, no more than about 23%, no more than about 21%, no more than about 19%, no more than about 17%, no more than about 15%, no more than about 14%, no more than about 13%, no more than about 12%, no more than about 11%, no more than about 10%, no more than about 9%, no more than about 8%, no more than about 7%, no more than about 6%, no more than about 5%, no more than about 4%, no more than about 3%, no more than about 2%, or no more than about 1%, inclusive of all values and ranges therebetween.

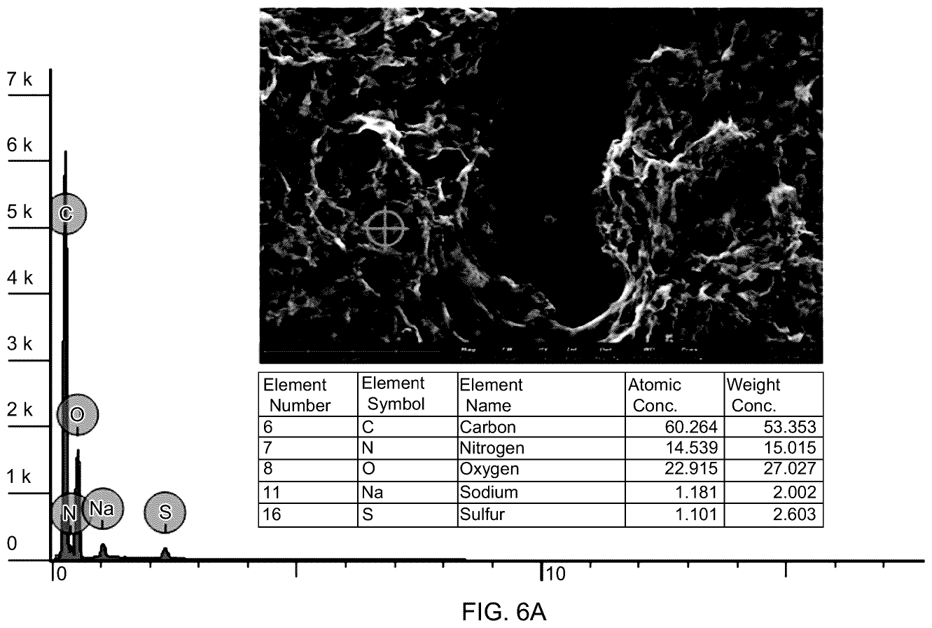

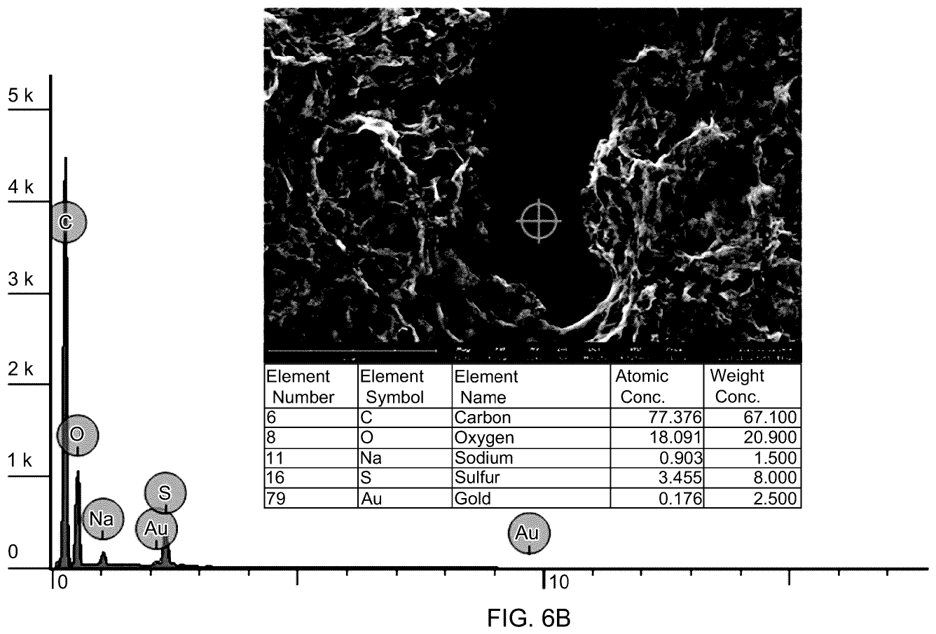

FIGS. 6A and 6B show a scanning electron microscopy (SEM) image of the surface of a 25 kDa PEI-GO polymer-modified graphene oxide membrane 100 prepared and/or produced according to an embodiment of the present disclosure. The 25 kDa PEI-GO polymer-modified graphene oxide membrane 100 has been prepared and/or produced by chemical reactions of a 25 kDa PEI polymeric component 120 with the GO sheets 110 present in graphene oxide (GO), as described above with reference to FIG. 3. The SEM images shown in FIGS. 6A and 6B reveal the surface of the PEI-GO polymer-modified graphene oxide membrane 100 is heterogenous, comprising a first type of region and/or domain in which the surface is smooth, and a second regions and/or domain in which the surface is rough and uneven. Energy dispersive spectroscopy (EDS) graphs were recorded on the surface of a PEI-GO polymer-modified graphene oxide membrane 100 with the purpose of determining the local composition and/or the distribution of PEI component 120 and the GO sheets 110 on the surface of the PEI-GO polymer-modified graphene oxide membrane 100. The EDS graph shown in FIG. 6A reveals the rough domains on the surface of PEI-GO polymer-modified graphene oxide membrane 100 comprise nitrogen, with a relative surface concentration of about 14.6% Nitrogen. In contrast, the EDS graph shown in FIG. 6B indicates that the smooth domains on the surface of PEI-GO polymer-modified graphene oxide membrane 100 do not include a detectable amount of Nitrogen. The presence of Nitrogen on the rough domains of the surface of PEI-GO polymer-modified graphene oxide membrane 100 suggest the rough domains have a high concentration of amide species (e.g., HNC═O), indicative of PEI polymeric component 120 rich regions. Similarly, the absence of nitrogen on the smooth domains of the surface of PEI-GO polymer-modified graphene oxide membrane 100 indicates that the smooth domains have a high concentration of GO sheets 110 (e.g., GO sheets 110 rich region) uncoated and/or not coupled to the PEI polymeric component 120. Said in other words, the EDS curves of FIGS. 6A and 6B reveal the PEI polymeric component 120 can be incorporated into clusters, regions and/or domains, surrounded by adjacent clusters, regions and/or domains of GO sheets 110 not coupled to the PEI polymeric component 120. FIG. 6A further indicates that PEI-GO polymer-modified graphene oxide membrane 100 may have a surface incorporation of PEI polymeric component 120 of about 14.6% in the PEI rich clusters and/or domains.

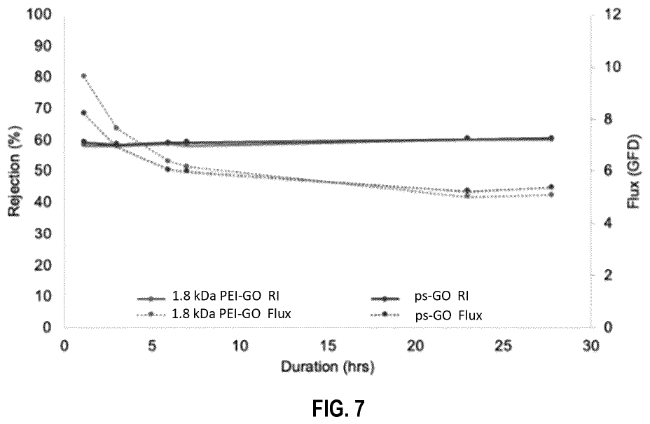

The performance of the filtration apparatus 1000 described herein can be characterized by the flux and the rejection rates for specific solute species. FIG. 7 shows a graph displaying the flux (GFD) and the rejection rate (%) of a filtration apparatus 1000 comprising a 1.8 kDa PEI-GO polymer-modified graphene oxide membrane 100 prepared and/or produced according to an embodiment of the present disclosure. The 1.8 kDa PEI-GO polymer-modified graphene oxide membrane 100 was prepared and/or produced by chemical reactions of a 1.8 kDa PEI polymeric component 120 with the GO sheets 110 present in graphene oxide (GO), as described above with reference to FIG. 3. The filtration apparatus 1000 shown in FIG. 7 included a polyethersulfone (PES) support 200 with a polypropylene (PP) nonwoven backing, displaying a nominal pore size of 10 kDa. FIG. 7 also shows the flux and the rejection rates for a filtration apparatus comprising a graphene oxide membrane including a propionamide chemical spacer 111 (ps-GO) membrane, and a similar support as the one included in the filtration apparatus 1000 (e.g., a PES support with a PP backing). The performance of the filtration apparatus described herein were measured using a crossflow filtration cell, flowing a Weak Black Liquor (WBL) solution at a temperature of at least 55° C., a crossflow velocity of 0.1 m/sec, and a pressure of about 300 psi. It is worth noticing that in some embodiments, the WBL solution can be flown trough a heat exchanger to adjust its temperature prior to directing the WBL solution to the filtration apparatus 1000, as described in International Patent Publication No. WO 2023/097166 A1, titled, “Heat Exchanger Integration with Membrane System for Evaporator Pre-Concentration,” filed Nov. 18, 2022 (“the '166 patent”), which is incorporated herein by reference. For example, in some embodiments the temperature of the WBL solution can be adjusted in a heat exchanger to about 55° C., about 60° C., about 65° C., about 70° C., about 75° C., about 80° C., about 85° C., or about 95° C. (inclusive of all values and ranges therebetween) prior to flowing the WBL solution to the filtration apparatus 1000. In some implementations, the temperature of the WBL solution can be decreased while flowing from the heat exchanger to the filtration apparatus 1000, and/or while being processed the filtration apparatus 1000. For example, in some embodiments the temperature of the WBL solution can be adjusted to about 70° C. using a heat exchanger, and then be received at the filtration apparatus 1000 at a temperature of about 69° C., about 68° C., about 65° C., about 63° C., about 60° C., about 58° C., about 55° C., or about 50 C (inclusive of all values and ranges therebetween). The WBL solution can be flown through one or more module(s) of the filtration apparatus 1000, with each module including at least one polymer-modified graphene oxide membrane 100. The temperature of the WBL solution can be further decreased while flowing through the different modules of the filtration apparatus. For example, in some embodiments, the WBL solution can be flown through the filtration apparatus 1000 (or a module thereof) at a temperature of at least about 50° C., at least about 53° C., at least about 55° C., at least about 57° C., at least about 59° C., at least about 61° C., at least about 63° C. at least about 65° C. at least about 68° C. at least about 70° C. at least about 75° C. at least about 80° C. at least about 85° C., or at least about 90° C. The WBL solutions can comprise sodium sulfate, sodium carbonate, sodium hydrosulfide, sodium thiosulfate, sodium hydroxide, tall oils, carbohydrates, lignin, cellulose, hemicellulose, or a combination thereof. The rejection rate for the solute species included in the WBL solution was measured by refractive index (RI) method in Degrees Brix. The rejection was calculated as calculated as

$$rej rate = ⌊ 1 - \frac{Permeate RI}{Feed RI} ⌋ \times 100.$$

The WBL solution feed used for the performance test in FIG. 7 had a refractive index between 15 and 16 Degrees Brix and a conductivity of about 46-48 mS. The ps-GO membrane was selected with the purpose of comparing the effect of the molecular weight of a polymeric component on the performance obtained by coupling the polymeric component to graphene oxide. The ps-GO membrane is further described in U.S. Pat. No. 11,097,227, titled, “Durable Graphene Oxide Membranes,” issued Aug. 24, 2021 (“the '864 patent”), which is incorporated herein by reference.

FIG. 7 shows the initial flux for the filtration apparatus 1000 including the 1.8 kDa PEI-GO polymer-modified graphene oxide membrane 100 was approximately 9.8 GFD, which quickly decreased during the first 5 hours of continuous operation in the WBL solution until reaching a relatively steady flux value of about 5.1 GFD for the remaining duration of the experiment. The flux of the filtration apparatus including the ps-GO membrane followed a very similar trend to that of the filtration apparatus 1000 with the 1.8 kDa PEI-GO polymer-modified graphene oxide membrane 100, exhibiting an initial flux of about 8.2 GFD which rapidly decreased until reaching a relatively steady state flux value of about 5.2 GFD. The rejection rate of the filtration apparatus 1000 with the 1.8 kDa PEI-GO polymer-modified graphene oxide membrane 100 and the filtration apparatus with the ps-GO membrane was nearly indistinguishable and remained relatively constant with a value close to 60% during entire duration of the experiment. The similarities in the performance of the filtration apparatus 1000 with the 1.8 kDa PEI-GO polymer-modified graphene oxide membrane 100 and the filtration apparatus with the ps-GO membrane suggests that improvements in the performance of GO membranes by incorporation of polymeric components 120 as those described herein, is highly dependent on the molecular weight of the polymeric component 120 selected. For example, the incorporation of a PEI polymeric component 120 having a relatively low molecular weight (e.g., 1.8 kDa) does not lead to significant improvements in flux and/or rejection rate as compared to coupling a small molecule like propionamide to graphene oxide. This is in stark contrast to the performance improvements observed with polymer components 120 having an average molecular weight greater than 1.8 kDa, as further described herein.

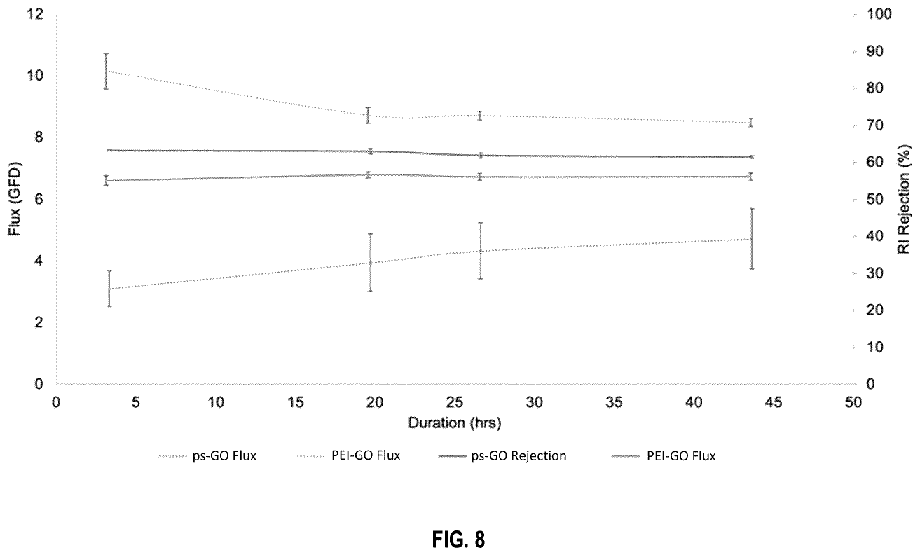

FIG. 8 shows a graph displaying rejection flux (GFD) and the rejection rate (%) of a filtration apparatus 1000 comprising a 25 kDa PEI-GO polymer-modified graphene oxide membrane 100 prepared and/or produced according to an embodiment of the present disclosure. The 25 kDa PEI-GO polymer-modified graphene oxide membrane 100 was prepared and/or produced by chemical reactions of a 25 kDa PEI polymeric component 120 with the GO sheets 110 present in graphene oxide (GO), as described above with reference to FIG. 3. FIG. 8 also shows the flux and rejection rates of a filtration apparatus comprising a graphene oxide membrane including the propionamide chemical spacer 111 (ps-GO) membrane, measured as a function of time flowing the same WBL solution described above with reference to FIG. 7 (e.g., RI of 15-15 degrees Brix, a conductivity of 46-48 mS, a Temperature of 70° C., a cross flow velocity of 0.9 Lt/min, and a pressure of 300 psig). FIG. 8 shows the initial flux for the filtration apparatus 1000 including the 25 kDa PEI-GO polymer-modified graphene oxide membrane 100 was approximately 10 GFD, which decreased steadily during the first 20 hours of continuous operation in the WBL solution until reaching a relatively steady flux value of about 8.7 GFD for the remaining duration of the experiment. The flux of the filtration apparatus 1000 with the 25 kDa PEI-GO polymer-modified graphene oxide membrane 100 is 1.8 times higher than the flux observed with the filtration apparatus having a ps-GO membrane, which exhibited an initial flux of about 3.2 GFD that increased overtime until reaching a maximum flux value of about 4.3 GFD. The difference in flux between the filtration apparatus 1000 with the 25 kDa PEI-GO polymer-modified graphene oxide membrane 100 and the filtration apparatus with the ps-GO membrane provides direct evidence of the flux improvements obtained by incorporating a polymeric component 120 as those described herein. The flux disclosed in FIG. 8 also provides evidence of the effect of the average molecular weight of the polymeric component 120 on the performance of the polymer-modified graphene oxide membrane 100. Comparison of the flux data in FIGS. 7 and 8 reveals that incorporation of a polymeric component 120 having a molecular weight higher than 1.8 kDa can lead to significant improvements in the flux of the filtration apparatus 1000. Without being bound by any particular theory, it is believed that incorporation of a polymeric component 120 with molecular weight greater than 1.8 kDa can increase the d-spacing of the GO sheets 110, allowing the membrane to achieve higher flux during membrane separation processes in WBL solutions. The high flux of the filtration apparatus 1000 having a polymer polymer-modified graphene oxide membrane 100 was not accompanied by a significant decrease in rejection rate. As shown in FIG. 8, the filtration apparatus 1000 with the 25 kDa PEI-GO polymer-modified graphene oxide membrane 100 had a nearly constant rejection rate of about 58%, whereas filtration apparatus having a ps-GO membrane exhibited a rejection rate of about 62%

The rejection rates described herein were measured using WBL solutions which contain solute species at the high concentrations (e.g., monovalent and/or divalent salts at 1 wt. % or higher) routinely found in commercially relevant applications and/or processes (e.g., black liquor or seawater processing). It is worth noting that the majority of prior art graphene oxide membranes typically report performance measurements conducted and/or evaluated at low solute concentrations (e.g., salt concentration<0.5 wt. %), particularly in laboratory settings, which may result in very high rejection rates (e.g., >90%) due to material absorption rather than membrane permeance. Increasing the concentration of the solute species present in the solution leads to a sharp reduction of the measured rejection rate. For example, the rejection rate of graphene oxide membranes measured using an aqueous solution containing 0.584 wt. % NaCl (˜0.1 M) can be as high as 80%. Increasing the concentration of NaCl in the aqueous solution from 0.584 wt. % to 2.92 wt. % (˜0.5 M) can decrease the rejection rate to about 45%. The high rejection rates typically observed at low salt concentrations are attributed to electrostatic repulsion between negatively charged carboxylic acid groups present on the graphene oxide (e.g., at pH>4) and the salt anions in the solution. Repulsion is particularly enhanced for divalent anions. As the concentration of salt is increased, the charges on the membrane are shielded by the ions present in the salt in solution, which causes the electrostatic repulsion to decrease. Under those conditions, the permeance of the filtration apparatus has a dominant effect on the observed rejection rate.

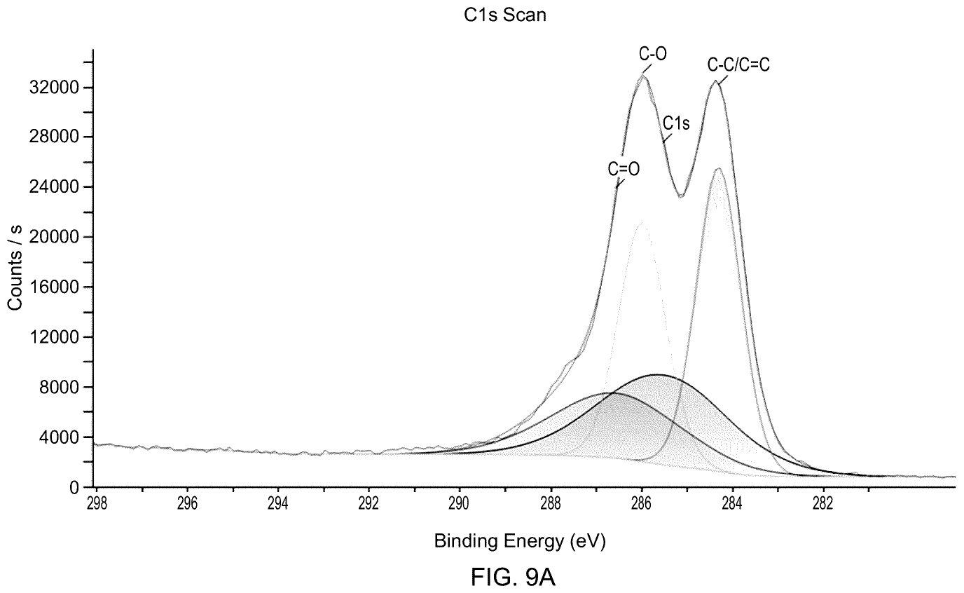

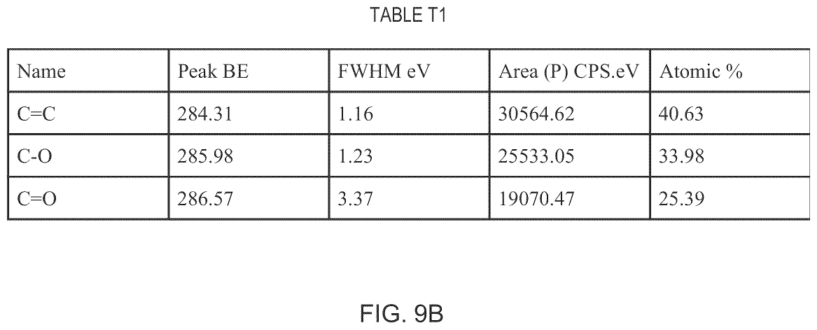

X-ray photoelectron spectroscopy (XPS) was used to determine the surface composition of the polymer-modified graphene oxide membranes 100 described herein and confirm the incorporation of polymeric components 120. FIGS. 9A and 9B show results from an X-Ray Photoelectron Spectroscopy (XPS) survey spectrum of a first 25 kDa PEI-GO polymer-modified graphene oxide membrane 100 prepared and/or produced according to an embodiment of the present disclosure. The first 25 kDa PEI-GO polymer-modified graphene oxide membrane 100 was prepared and/or produced by chemical reactions of a 25 kDa PEI polymeric component 120 with the GO sheets 110 present in graphene oxide (GO), similar to the procedure described below in Example 1. The first 25 kDa PEI-GO polymer-modified graphene oxide membrane 100 in FIGS. 9A-9B contained 63.17% carbon, 30.36% oxygen, and 2.67% nitrogen by XPS calculated using the survey spectrum. The difference in magnitude between atomic percentages measured by XPS (shown in FIGS. 9A and 9B) and atomic percentages measured by EDS (shown in FIGS. 6A-6B) are likely due to XPS being a strictly surface technique which does not accurately capture material within the membrane. This suggests the majority of the PEI is intercalated between the GO sheets 110 instead of sitting on the surface of the membrane. Analysis of the CIS peak, shown in Table T1 in FIG. 9B, reveals the first 25 kDa PEI-GO polymer-modified graphene oxide membrane 100 had an Atomic % distribution of carbon species including about 40.6% (C═C), 33.9% (C—O), and 25% (C═O). This is in contrast to prior art graphene oxide membranes which typically have a much lower content of C═C and C═O species, with a majority of carbon being (C—C) species (e.g., 80-90% C—C).

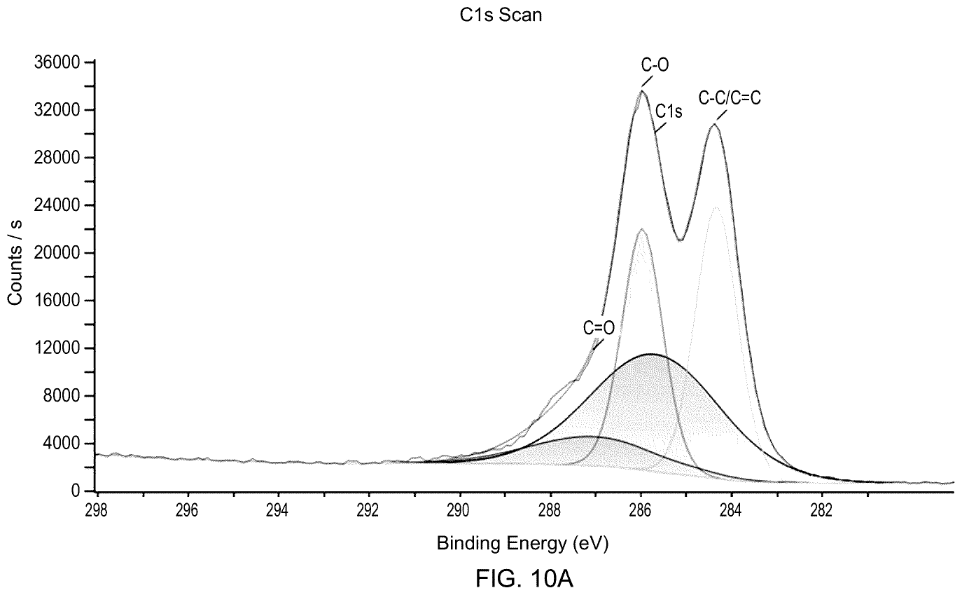

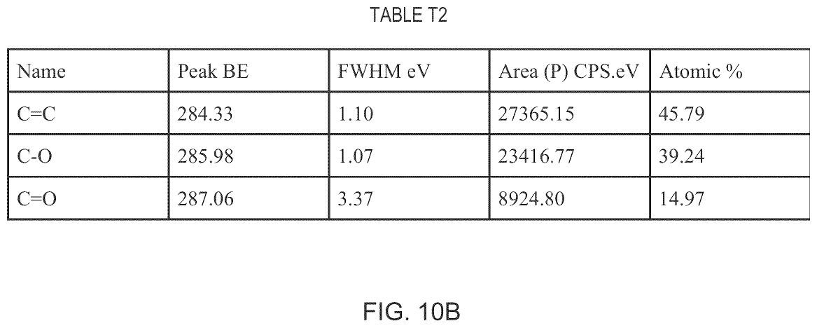

FIGS. 10A and 10B show results from an X-Ray Photoelectron Spectroscopy (XPS) survey spectrum of a second 25 kDa PEI-GO polymer-modified graphene oxide membrane 100 prepared and/or produced according to an embodiment of the present disclosure. The second 25 kDa PEI-GO polymer-modified graphene oxide membrane 100 was prepared and/or produced by chemical reactions of a 25 kDa PEI polymeric component 120 with the GO sheets 110 present in graphene oxide (GO), similar to the procedure described below in Example 2. Analysis of the of the C1S peak, shown in Table T2 in FIG. 10B, reveals the second 25 kDa PEI-GO polymer-modified graphene oxide membrane 100 had an Atomic % distribution of carbon species including about 45.8% (C═C), 39.2% (C—O), and 14% (C═O). The variations in the distribution of carbon species in the polymer-modified graphene oxide membrane 100 can cause changes and/or variations in the amount of polymeric component 120 coupled to the GO sheets 110, and thus the flux and rejection exhibited by the filtration apparatus. Without being bound by any particular theory, it is believed that the increased surface concentration of C═C and C═O species on the GO sheets 110 can increase the reactivity of graphene oxide for the incorporation of polymeric components 120, which in turn can translate in significant improvements in flux and rejection rate of the filtration apparatus.

### Manufacture of the Filtration Apparatus

The fabrication of the filtration apparatus 1000 described above with reference to FIGS. 1A-1B involves preparing a GO sheets 110 solution and/or dispersion, adding a polymeric component 120 as well as one or more additives, initiating one or more chemical reactions and/or transformations that incorporate the polymeric component 120 to the GO sheets 110 producing a polymer-modified graphene oxide 100 solution and/or dispersion, and depositing the resulting polymer-modified graphene oxide 100 solution and/or dispersion on the support 200. In some embodiments, the fabrication of the polymer-modified graphene oxide membrane 100 includes dispersing GO sheets 110 in a solvent to produce a stable dispersion. In some embodiments, the solvent can be water. In some embodiments, the solvent can be an organic solvent. The dispersion may exhibit certain physical and chemical characteristics in order to produce continuous and uniform coatings substantially free of structural defects such as pinholes. For example, the hydrophilicity of the dispersion should be adequately matched to that of the support 200 to ensure wetting of the support 200 surface. This can be tested by contact angle measurements.

The stability of the dispersions can be inferred from the pH of the dispersion. For example, dispersions that exhibit acidic pH values (e.g., pH<5) can develop visible aggregates. Fabricating coatings with such dispersions can lead to poor coverage, coating non-uniformity, and poor membrane performance. In contrast, dispersions that have basic pH are stable. Moreover, addition of basic additives to the dispersion can increase the magnitude of the zeta potential on the GO sheets 110, which in turn results in greater Coulombic stabilization.

The stability of the dispersion can be indirectly observed through UV-Vis spectroscopy measurements, owing to the absorption band at around 300 nm, attributed to n-to-p* transitions. At longer wavelengths (>500 nm) the GO sheets 110 absorb very weakly, and consequently, any signal in this region can be attributed to scattering, rather than absorption, due to the formation of aggregates. The ratio of UV-Vis signal at 300 nm (due to absorption) and that observed at 600 nm (due to aggregate scattering) can be used to characterize the dispersion in the solution. Generally, the higher this ratio is, the better the GO sheets 110 are dispersed.

In some embodiments, the ratio of UV-Vis signal at 300 nm and that observed at 600 nm can be less than about 4.4, less than about 4.2, less than about 4.0, less than about 3.8, less than about 3.6, less than about 3.4, less than about 3.2, or less than about 3.0, inclusive of all values and ranges therebetween. In some embodiments, the ratio of UV-Vis signal at 300 nm and that observed at 600 nm can be at least about 3.0, at least about 3.1, at least about 3.2, at least about 3.3, or at least about 3.4, inclusive of all values and ranges therebetween.

Combinations of the above referenced ranges for the ratio are also possible (e.g., a ratio of at least about 3.0 to less than about 4.4, at least about 3.2 to less than about 4.0).

In some embodiments, the dispersion can further include viscosity modifiers and/or surfactants. In some embodiments, the viscosity modifier is hydroxypropyl methyl cellulose (HPMC). For example, the dispersion can include 0.01 wt. % viscosity modifier. In some embodiments, the surfactant is sodium dodecyl sulfide (SDS). For example, the dispersion can include about 0.15 wt. % surfactant.

In some embodiments, the viscosity of the dispersion can be no more than about 20 cP at a shear rate of around 0.08 Hz, about 40 cP at a shear rate of around 0.08 Hz, about 60 cP at a shear rate of around 0.08 Hz, about 100 cP at a shear rate of around 0.08 Hz, about 200 cP at a shear rate of around 0.08 Hz, about 400 cP at a shear rate of around 0.08 Hz, about 600 cP at a shear rate of around 0.08 Hz, about 800 cP at a shear rate of around 0.08 Hz, 1000 cP at a shear rate of around 0.08 Hz, no more than about 1500 cP at a shear rate of around 0.08 Hz, no more than about 2000 cP at a shear rate of around 0.08 Hz, no more than about 2500 cP at a shear rate of around 0.08 Hz, no more than about 3000 cP at a shear rate of around 0.08 Hz, no more than about 3000 cP at a shear rate of around 0.08 Hz, no more than about 3500 cP at a shear rate of around 0.08 Hz, no more than about 4000 cP at a shear rate of around 0.08 Hz, no more than about 5000 cP at a shear rate of around 0.08 Hz, no more than about 6000 cP at a shear rate of around 0.08 Hz, or no more than about 8000 cP at a shear rate of around 0.08 Hz.

Combinations of the above referenced ranges for the viscosity of the dispersion are also possible (e.g., a viscosity of at least about 10 cP and to no more than about 1000 cP at a shear rate of around 0.08 Hz, at least about 200 cP to no more than about 1500 cP at a shear rate of around 0.08 Hz).

As described above, the fabrication of the filtration apparatus 1000 involves preparing polymer-modified graphene oxide 100 solution and/or dispersion. In some embodiments, the fabrication of the polymer-modified graphene oxide 100 solution and/or dispersion includes dispersing graphene oxide sheets (e.g., the GO Sheets 110) in a solvent to produce a GO sheet 110 solution/dispersion as described above. In some embodiments, one or more chemical reagents and/or additives can be added to the GO sheets 110 solution/dispersion. For example, in some embodiments a predetermined amount of a solvent can be added to the GO sheets 110 solution/dispersion to adjust the concentration of GO sheets 110 in the solution/dispersion. In some embodiments, a predetermined amount of a pH adjusting reagent can be added to the GO sheets 110 solution/dispersion. For example, in some embodiments a predetermined amount of a base, a salt, a buffer and/or the like can be added to the GO sheets 110 solution/dispersion to adjust the pH. In some embodiments, the GO sheets 110 solution/dispersion can be agitated, stirred, sonicated, mixed, and/or the like to mix and/or disperse the GO sheets 110 and the added reagents. In some embodiments the GO sheets 110 solution/dispersion can be agitated, stirred, sonicated, mixed for a predetermined period of time. In some embodiments, the predetermined period of time can be at least about 5 min, at least about 10 min, at least about 15 min, at least about 20 min, at least about 25 min, at least about 30 min, at least about 35 min, at least about 40 min, at least about 45 min, at least about 50 min, at least about 60 min, at least about 70 min, at least about 80 min, at least about 90 min, at least about 100 min, at least about 110 min, or at least about 120 min, inclusive of all values and ranges therebetween.

In some embodiments, one or more polymeric component 120 can be added to the GO sheets 110 solution/dispersion. In some embodiments, the polymeric component 120 can be mixed with the GO sheets 110 solution/dispersion using any suitable means. For example, in some embodiments the polymeric component 120 can be added to the GO sheets 110 solution/dispersion and the resulting mixture can be stirred using a high shear mixer. In some embodiments, the polymeric component 120 can be incorporated to the GO sheets 110 via carbodiimide coupling reactions. In such embodiments, the GO sheets 110 with the polymeric component 120 can be first treated with a suitable additive such as a base, and acid, a salt and/or a buffer to adjust the pH between 7 and 8.5, prior to adding carbodiimide coupling reagents such as 1-Ethyl-3-(3-dimethylaminopropyl)carbodiimide (EDC) and N-hydroxysuccinimide (NHS).

In some embodiments, the GO sheets 110 solution/dispersion with the carbodiimide coupling reagents and the polymeric component 120 can be allowed to react for a period of time under stirring conditions to produce a polymer-modified graphene oxide solution/dispersion. The resulting polymer-modified graphene oxide solution/dispersion can then be filtered and resuspended in a suitable solvent. In some embodiments, the GO sheets 110 solution/dispersion, the polymeric component 120, and/or any included additive (e.g., a carbodiimide coupling reagent) can be allowed to react at a predetermined temperature. In some embodiments, this predetermined temperature can be room temperature. In other embodiments, the predetermined temperature can be at least about 28° C., at least about 30° C., at least about 32° C., at least about 34° C., at least about 36° C., at least about 38° C., at least about 40° C., at least about 42° C., at least about 44° C., at least about 46° C., at least about 48° C., at least about 50° C., at least about 52° C., at least about 54° C., at least about 56° C., at least about 58° C., or at least about 60° C., inclusive of all values and ranges therebetween. In other embodiments, the predetermined temperature for the reaction of the GO sheets 110 solution/dispersion, the polymeric component 120, and/or any included additive (e.g., a carbodiimide coupling reagent) can be no more than about 65° C., no more than about 60° C., no more than about 55° C., no more than about 50° C., no more than about 45° C., no more than about 40° C., no more than about 35° C., no more than about 30° C., or no more than about 25° C., inclusive of all values and ranges therebetween.

As described above, the fabrication of the filtration apparatus 1000 requires depositing a polymer-modified graphene oxide solution and/or dispersion on the support 200. In some embodiments, the polymer-modified graphene oxide solution and/or dispersion can be deposited on the support 200 using one or more coating techniques. For example, in some embodiments the polymer-modified graphene oxide solution and/or dispersion can be deposited using coating techniques such as solvent casting, spin coating, cold spray coating, dip casting, drop casting, and/or tape casting. In some embodiments, a polymer-modified graphene oxide solution and/or dispersion can be coated onto one side of a support 200 using a casting rod. The casted polymer-modified graphene oxide solution and/or dispersion can then be allowed to dry at room temperature and/or at any suitable temperature (e.g., in an oven) to produce the polymer-modified graphene oxide membrane 100. Additionally and/or optionally, in some embodiments, the polymer-modified graphene oxide membrane 100 can be further washed with a suitable solvent. For example, in some embodiments, the polymer-modified graphene oxide membrane 100 can be washed with one or more solvents including, but not limited to ethanol, propanol, and/or any suitable aliphatic alcohol (e.g., R—OH), dichloromethane, acetonitrile, dimethyl sulfoxide, acetone, dimethylformamide (DMF), dioxane, butanone, carbon tetrachloride

The fabrication of the filtration apparatus 1000′ described above with reference to FIGS. 2A-2C involves similar procedures as described above with respect to the filtration apparatus 1000. For example, fabrication of the graphene oxide membrane 100′ includes dispersing GO sheets 110 in a solvent to produce a stable dispersion. In some embodiments, the solvent can be water. In some embodiments, the solvent can be an organic solvent. The dispersion may exhibit certain physical and chemical characteristics in order to produce continuous and uniform coatings substantially free of structural defects such as pinholes. For example, the hydrophilicity of the dispersion should be adequately matched to the support 200 to ensure wetting of the support 200 surface. This can be tested by contact angle measurements.

The stability of the dispersion can be inferred from the pH of the dispersion. For example, dispersions that exhibit acidic pH values (e.g., pH<5) can develop visible aggregates. Fabricating coatings with such dispersions lead to poor coverage, coating non-uniformity, and poor membrane performance. In contrast, dispersions that have basic pH are stable. Moreover, addition of basic additives to the dispersion can increase the magnitude of the zeta potential on the GO sheets 110, which in turn results in greater Coulombic stabilization.

The stability of the dispersion can be indirectly observed through UV-Vis spectroscopy measurements, owing to the absorption band at around 300 nm, attributed to n-to-p* transitions. At longer wavelengths (>500 nm) the GO sheets 110 absorb very weakly, and consequently, any signal in this region can be attributed to scattering, rather than absorption, due to the formation of aggregates. The ratio of UV-Vis signal at 300 nm (due to absorption) and that observed at 600 nm (due to aggregate scattering) can be used to characterize the dispersion in the solution. Generally, the higher this ratio is, the better the GO sheets 110 are dispersed.

In some embodiments, the ratio of UV-Vis signal at 300 nm and that observed at 600 nm can be less than about 4.4, less than about 4.2, less than about 4.0, less than about 3.8, less than about 3.6, less than about 3.4, less than about 3.2, or less than about 3.0, inclusive of all values and ranges therebetween. In some embodiments, the ratio of UV-Vis signal at 300 nm and that observed at 600 nm can be at least about 3.0, at least about 3.1, at least about 3.2, at least about 3.3, or at least about 3.4, inclusive of all values and ranges therebetween.

Combinations of the above referenced ranges for the ratio are also possible (e.g., a ratio of at least about 3.0 to less than about 4.4, at least about 3.2 to less than about 4.0).

In some embodiments, the dispersion can further include viscosity modifiers and/or surfactants. In some embodiments, the viscosity modifier is hydroxypropyl methyl cellulose (HPMC). For example, the dispersion can include 0.01 wt % viscosity modifier. In some embodiments, the surfactant is sodium dodecyl sulfide (SDS). For example, the dispersion can include about 0.15 wt % surfactant.

In some embodiments, the viscosity of the dispersion can be no more than about 100 cP at a shear rate of around 50 Hz, no more than about 90 cP at a shear rate of around 50 Hz, no more than about 80 cP at a shear rate of around 50 Hz, or no more than about 70 cP at a shear rate of around 50 Hz. In some embodiments, the viscosity of the dispersion can be at least about 10 cP at a shear rate of around 50 Hz, at least about 20 cP at a shear rate of around 50 Hz, or at least about 30 cP at a shear rate of around 50 Hz.

Combinations of the above referenced ranges for the viscosity of the dispersion are also possible (e.g., a viscosity of at least about 10 cP and to no more than about 100 cP at a shear rate of around 50 Hz, at least about 20 cP to no more than about 90 cP at a shear rate of around 50 Hz).

To produce dispersions that can coat well onto the support 200, the order of addition of reagents can be important. For example, prior to deposition, dispersions that undergo carbodiimide coupling conditions require adjustment of the pH to be greater than 8.0 prior to the addition of 1-Ethyl-3-(3-dimethylaminopropyl)carbodiimide (EDC) and N-hydroxysuccinimide (NHS).

Prior to the reaction with a chemical spacer 111 precursor, the GO sheets 110 can be functionalized with one or more desirable chemical groups. For example, the GO sheets 110 can be functionalized with amines. See Navaee, A. & Salimi, A, “Efficient amine functionalization of graphene oxide through the Bucherer reaction: an extraordinary metal-free electrocatalyst for the oxygen reduction reaction,” RSC Adv. 5, 59874-59880 (2015), the contents of which are incorporated by reference.

The GO sheets 110 can also be functionalized with carboxylic groups. See Sydlik, S. A. & Swager, T. M., “Functional Graphenic Materials via a Johnson—Claisen Rearrangement,” Adv. Funct. Mater. 23, 1873-1882 (2012); Collins, W. R., et al., “Rearrangement of Graphite Oxide: A Route to Covalently Functionalized Graphenes” Angew. Chem., Int. Ed. 50, 8848-8852 (2011), the contents of each of which are incorporated by reference.

In some embodiments, the GO sheets 110 can be functionalized with hydroxyl groups. For example, a GO sheet 110 can react with an epoxide so that the GO sheet 110 is functionalized with hydroxyl groups. Examples of epoxides include, but are not limited to, 1-2-epoxypropane, styrene oxide, ethylene oxide, epichlorohydrine, 1,2-epoxybutane, bisphenol, A diglycidyl ether, 1, 3-butadiene diepoxide and 1,2,7,8-diepoxyoctane.

Once the GO sheets 110 have the desired chemical groups, they can be placed in contact with the chemical spacer 111 precursor to initiate a reaction between the GO sheets 110 and the chemical spacer precursor 111. The reaction conditions can vary, depending on the chemical spacer 111 used. As compared to existing processes, some embodiments of the process of the present disclosure can be performed under ambient environments (i.e., in the presence of oxygen and humidity).

In some embodiments, the GO sheets 110 can be optionally coupled to an adjacent GO sheet 110 via a chemical linker 130. In some embodiments molecules useful for initiating crosslinking between GO sheets 110 can include, but are not restricted to, ester groups, sulfonated esters, ether groups, amines, carboxyl groups, carboxylic acids, carbonyl groups, amides, halides, thiols, alkanes, fluoroalkanes, alkyl groups, methyl groups, ethyl groups, propyl groups, butyl groups, pentyl groups, heptyl groups, octyl groups, nonyl groups, decyl groups, isopropyl, cyclopropyl, isobutyl, t-butyl, cyclobutyl, cyclohexyl, chloromethyl, bromoethyl, trifluoromethyl, methylamine, dimethylamine, ethylamine, diethylamine, methylethylamine, iso-propylamine, piperidine, trimethylamine, propylamine, hydroxy groups, hydroxyl groups, thio groups, 1,3,5-benzenetricarbonyl trichloride, aromatic dichlorides, aromatic trichlorides, terephthaloyl chloride, adipoyl chloride, propanediol, pentanediol, hexanediol, heptanediol, naphthyl, biphenyl, benzyl, hexyldiamine, 1,6-diiodohexane, 1,6-dibromohexane, 1,6-dichlorohexane, α,α′-dichloro-p-xylene, α,α′-diiodo-p-xylene, α,α′-dibromo-p-xylene, dichloromethylnapthalene, trichloromethylbenzene, dichloromethylbiphenyl, dibromomethylnapthalene, tribromomethylbenzene, dibromomethylbiphenyl, diiodomethylnapthalene, triiodomethylbenzene, diiodomethylbiphenyl, any other suitable crosslinking moieties, or combinations thereof.

In some embodiments, crosslinking moieties can be coupled to at least one GO sheet 110 through esterification under appropriate reaction conditions.

The polymeric additive 300 can be deposited on the graphene oxide membrane 100′ according to a procedure that includes (1) weighing an amount of the polymeric additive, (2) dissolving the polymeric additive in water with the aid of a suitable chemical mixing equipment such as a mechanical agitator, a shaker and/or a magnetic stirrer, thereby producing a polymeric additive solution, (3) casting the polymeric additive solution onto the graphene oxide membrane 100′ in a uniform movement using a rod caster having a specific rod size for the desired thickness, and (4) drying the polymeric additive 300 in a fume hood for 12 hours, followed by drying at 80° C. for 90 min. Optionally, the procedure can include heating the polymeric additive solution at a temperature as high as 90° C. after addition of the polymeric additive 300.

### Applications

The filtration apparatus 1000 disclosed herein can be used for a wide range of nanofiltration or microfiltration applications, including but not limited to, concentration of molecules (e.g., whey, lactose), kraft pulping (e.g., wood pulp), sulfite pulping, demineralization or desalting (e.g., lactose, dye, chemicals, pharmaceuticals), fractionation (e.g., sugars), extraction (e.g., nutraceuticals, plant oils), recovery (e.g., catalyst, solvent), and purification (e.g., pharmaceutical, chemical, fuel), as well as applications in which high chemical stability and high monovalent and divalent ion rejection are required, such as acid concentration, sucrose concentration, and/or homogeneous catalyst concentration and/or purification. For example, a fluid comprising a plurality of species (e.g., plurality of retentate species) may be placed in contact with a first side of the polymer-modified graphene oxide membrane 100. The polymer-modified graphene oxide membrane 100 may have interlayer spacing and/or intralayer spacing that are sized to prevent at least a portion of the species from traversing the membrane through the interlayer spacing and/or intralayer spacing, i.e., flowing from the first side of the polymer-modified graphene oxide membrane and to a second, opposing side of the polymer-modified graphene oxide membrane 100. In some embodiments, the fluid may include one or more types of species (e.g., a retentate species or a permeate species). In some embodiments, the polymer-modified graphene oxide membrane 100 may have an average interlayer spacing and/or intralayer spacing that is sized to prevent at least a portion of the retentate species from traversing the polymer-modified graphene oxide membrane, while allowing at least a portion (e.g., substantially all) of the permeate species to traverse the polymer-modified graphene oxide membrane.

The filtration apparatus 1000 disclosed herein can also be used for the concentration of black liquor. Weak black liquor (WBL) solutions from pulp digestion is generally produced at 80° C. to 90° C. Cooling the WBL prior to filtration would be very expensive and energy intensive. Without the need for cooling, the WBL can pass through the graphene oxide membrane described herein at a high temperature, e.g., 60° C. to 75° C., 75° C. to 85° C., or 80° C. to 90° C., inclusive of all values and ranges therebetween. In some embodiments, WBL solutions can be flowed through the filtration apparatus 1000 described herein, wherein the WBL solution comprises lignin, sodium sulfate, sodium carbonate, sodium hydrosulfide, sodium thiosulfate, sodium hydroxide, as well as larger size organic species including hemicellulose, and cellulose.

In some embodiments, the WBL solutions can include a content of total dissolved solids prior to filtration of at least about 2 wt. %, at least about 3 wt. %, at least about 5 wt. %, at least about 7 wt. %, at least about 9 wt. %, at least about 11 wt. %, at least about 13 wt. %, at least about 15 wt. %, at least about 17 wt. % at least about 19 wt. %, at least about 21 wt. %, at least about 23 wt. %, or at least about 25 wt. %, inclusive of all values and ranges therebetween. In some embodiments, the WBL solutions can include a content of total dissolved solids of no more than about 25 wt. %, no more than about 22 wt. %, no more than about 20 wt. %, no more than about 18 wt. %, no more than about 16 wt. %, no more than about 14 wt. %, no more than about 12 wt. %, no more than about 10 wt. %, no more than about 8 wt. %, no more than about 6 wt. %, no more than about 4 wt. %, or no more than about 2 wt. %, inclusive of all values and ranges therebetween.

In some embodiments, the WBL solutions can have a pH prior to filtration of about 10, of about 10.5, of about 11, of about 11.5, of about 12, of about 12.5, or of about 13.

The performance of the filtration apparatus 200 for WBL filtration can be assessed by the rejection rate on a total solids basis. In some embodiments, the rejection rate is between about 55% and about 85% on a total solids basis, e.g., between about 60% and about 70%, between about 65% and about 75%, or between 70% and about 85% on a total solids basis.

In some embodiments, the filtration apparatus 1000 can reject at least a portion of the lignin. In some embodiments, the filtration apparatus 1000 can reject at least about 50%, at least about 55%, at least about 60%, at least about 65%, at least about 70%, at least about 75%, or at least about 85% of the lignin.

In some embodiments, the filtration apparatus 1000 support 200 can reject at least a portion of the sodium sulfate. In some embodiments, the filtration apparatus 1000 can reject at least about 50%, at least about 55%, at least about 60%, at least about 65%, at least about 70%, at least about 75%, or at least about 85% of the sodium sulfate.

In some embodiments, the filtration apparatus 1000 can reject at least a portion of the sodium carbonate. In some embodiments, the filtration apparatus 1000 can reject at least about 50%, at least about 55%, at least about 60%, at least about 65%, at least about 70%, at least about 75%, or at least about 85% of the sodium carbonate.

In some embodiments, the filtration apparatus 1000 can reject at least a portion of the sodium hydrosulfide. In some embodiments, the filtration apparatus 1000 can reject at least about 50%, at least about 55%, at least about 60%, at least about 65%, at least about 70%, at least about 75%, or at least about 85% of the sodium hydrosulfide.

In some embodiments, the filtration apparatus 1000 can reject at least a portion of the sodium thiosulfate. In some embodiments, the filtration apparatus 1000 can reject at least about 50%, at least about 55%, at least about 60%, at least about 65%, at least about 70%, at least about 70%, or at least about 85% of the sodium thiosulfate.

In some embodiments, the filtration apparatus 1000 can reject at least a portion of the sodium species included in the WBL solution. In some embodiments, the filtration apparatus 1000 can reject at least about 50%, at least about 55%, at least about 60%, at least about 65%, at least about 70%, at least about 75%, or at least about 75% of the sodium species included in the WBL solution.

The filtration apparatus 1000 disclosed herein can be used in reverse osmosis to remove ions, molecules, and larger particles from a fluid, e.g., drinking water.

In some embodiments, the filtration apparatus 1000 disclosed herein can be used in methods for filtering raw milk, cheese whey, whey protein concentrate, mixtures comprising lactose, and whey protein isolate. The methods can include flowing the raw milk through the graphene oxide membrane.

In some embodiments, the filtration apparatus 1000 can have a flux greater than about 4.0 GFD, greater than about 4.5 GFD, greater than about 5.0 GFD, greater than about 5.5 GFD, greater than about 6.0 GFD, greater than about 6.5 GFD, greater than about 7.0 GFD, greater than about 7.5 GFD, greater than about 8.0 GFD, greater than about 8.5 GFD, greater than about 9.0 GFD, greater than about 9.5 GFD, greater than about 10 GFD, greater than about 12 GFD, greater than about 14 GFD, greater than about 16 GFD, greater than about 18 GFD, greater than about 20 GFD, greater than about 25 GFD, greater than about 30 GFD, greater than about 40 GFD, or greater than about 50 GFD, measured with a weak black liquor solution containing between about 2 and 20 wt. % total dissolved solids including, for example, sodium sulfate, sodium carbonate, sodium hydrosulfide, sodium thiosulfate, sodium hydroxide, tall oils, carbohydrates, lignin, cellulose, hemicellulose, or a combination thereof, at a cross flow velocity of at least 0.1 m/sec, a predetermined pressured, and a temperature of at least 50° C.

In some embodiments, the filtration apparatus 1000 can have a flux of less than about 50 GFD, less than about 40 GFD, less than about 30 GFD, less than about 20 GFD, less than about 15 GFD, less than about 10GFD, measured with weak black liquor at a cross flow velocity of at least 0.9 Liters per minute (LPM), a predetermined pressure, and a temperature of at least 50° C.

Combinations of the above-referenced ranges for the flux are also contemplated (e.g., greater than about 8.0 GFD and less than about 12 GFD, or greater than about 5 GFD and less than about 30 GFD).

In some embodiments, the flux is measured at a predetermined pressure of 50 psi to 1000 psi, such as about 50 psi, about 75 psi, about 100 psi, about 125 psi, about 150 psi, about 175 psi, about 200 psi, about 225 psi, about 250 psi, about 275 psi, about 300 psi, about 325 psi, about 350 psi, about 375 psi, about 400 psi, about 425 psi, about 450 psi, about 475 psi, about 500 psi, about 525 psi, about 550 psi, about 575 psi, about 600 psi, about 625 psi, about 650 psi, about 675 psi, about 700 psi, about 725 psi, about 750 psi, about 775 psi, about 800 psi, about 825 psi, about 850 psi, about 875 psi, about 900 psi, about 925 psi, about 950 psi, about 975 psi, or about 1000 psi.

The filtration apparatus disclosed herein can be used in reverse osmosis to remove ions, molecules, and larger particles from a fluid, e.g., drinking water.

In some embodiments, the filtration apparatus disclosed herein can be used in methods for filtering raw milk, cheese whey, whey protein concentrate, mixtures comprising lactose, and whey protein isolate. The methods can include flowing the raw milk through the graphene oxide membrane.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

### Definitions

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.” Any ranges cited herein are inclusive.

The terms “substantially,” “approximately,” and “about” used throughout this Specification and the claims generally mean plus or minus 10% of the value stated, e.g., about 100 would include 90 to 110.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/of” should be construed in the same fashion, i.e., “one or more” of the elements so conjoined. Other elements may optionally be present other than the elements specifically identified by the “and/of” clause, whether related or unrelated to those elements specifically identified. Thus, as a non-limiting example, a reference to “A and/or B”, when used in conjunction with open-ended language such as “comprising” may refer, in one embodiment, to A only (optionally including elements other than B); in another embodiment, to B only (optionally including elements other than A); in yet another embodiment, to both A and B (optionally including other elements); etc.

As used herein in the specification and in the claims, “of” should be understood to have the same meaning as and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

As used herein, the term “graphene oxide sheet” means a single atomic graphene oxide layer or a plurality of atomic graphene oxide layers. Each atomic graphene oxide layer may include out-of-plane chemical moieties attached to one or more carbon atoms on the layer. In some embodiments, the term “graphene oxide sheet” means 1 to about 20 atomic graphene oxide layers, e.g., 1 to about 18, 1 to about 16, 1 to about 14, 1 to about 12, 1 to about 10, 1 to about 8, 1 to about 6, 1 to about 4, or 1 to about 3 atomic graphene oxide layers. In some embodiments, the term “graphene oxide sheet” means 1, 2, or 3 atomic graphene oxide layers.

As used herein, the term “basic” means pH greater than 7.

As used herein, “wt. %” refers to weight percent.

As used herein, the term “flux” means flow rate. It describes the permeability of a membrane.

As used herein, the term “optionally substituted” is understood to mean that a given chemical moiety (e.g., an alkyl group) can (but is not required to) be bonded other substituents (e.g., heteroatoms). For instance, an alkyl group that is optionally substituted can be a fully saturated alkyl chain (i.e., a pure hydrocarbon). Alternatively, the same optionally substituted alkyl group can have substituents different from hydrogen. For instance, it can, at any point along the chain be bounded to a halogen atom, a hydroxyl group, or any other substituent described herein. Thus the term “optionally substituted” means that a given chemical moiety has the potential to contain other functional groups, but does not necessarily have any further functional groups. Suitable substituents used in the optional substitution of the described groups include, without limitation, halogen, oxo, —OH, —CN, —COOH, —CH2CN, —O—(C1-C6) alkyl, (C1-C6) alkyl, C1-C6 alkoxy, (C1-C6) haloalkyl, C1-C6 haloalkoxy, —O—(C2-C6) alkenyl, —O—(C2-C6) alkynyl, (C2-C6) alkenyl, (C2-C6) alkynyl, —OH, —OP(O)(OH)2, —OC(O)(C1-C6) alkyl, —C(O)(C1-C6) alkyl, —OC(O)O(C1-C6) alkyl, —NH2, —NH((C1-C6) alkyl), —N((C1-C6) alkyl)2, —NHC(O)(C1-C6) alkyl, —C(O)NH(C1-C6) alkyl, —S(O)2(C1-C6) alkyl, —S(O)NH(C1-C6) alkyl, and —S(O)N((C1-C6) alkyl)2. The substituents can themselves be optionally substituted.

As used herein, the term “hydroxy” or “hydroxyl” refers to the group —OH or —O—.

As used herein, “halo” or “halogen” refers to fluoro, chloro, bromo, and iodo.

The term “carbonyl” includes compounds and moieties which contain a carbon connected with a double bond to an oxygen atom. Examples of moieties containing a carbonyl include, but are not limited to, aldehydes, ketones, carboxylic acids, amides, esters, anhydrides, etc.

The term “carboxyl” refers to —COOH or its C1-C6 alkyl ester.

“Acyl” includes moieties that contain the acyl radical (R—C(O)—) or a carbonyl group. “Substituted acyl” includes acyl groups where one or more of the hydrogen atoms are replaced by, for example, alkyl groups, alkynyl groups, halogen, hydroxyl, alkylcarbonyloxy, arylcarbonyloxy, alkoxycarbonyloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, amino (including alkylamino, dialkylamino, arylamino, diarylamino and alkylarylamino), acylamino (including alkylcarbonylamino, arylcarbonylamino, carbamoyl and ureido), amidino, imino, sulfhydryl, alkylthio, arylthio, thiocarboxylate, sulfates, alkylsulfinyl, sulfonato, sulfamoyl, sulfonamido, nitro, trifluoromethyl, cyano, azido, heterocyclyl, alkylaryl, or an aromatic or heteroaromatic moiety.

The term “alkoxy” or “alkoxyl” includes substituted and unsubstituted alkyl, alkenyl and alkynyl groups covalently linked to an oxygen atom. Examples of alkoxy groups or alkoxyl radicals include, but are not limited to, methoxy, ethoxy, isopropyloxy, propoxy, butoxy and pentoxy groups. Examples of substituted alkoxy groups include halogenated alkoxy groups. The alkoxy groups can be substituted with groups such as alkenyl, alkynyl, halogen, hydroxyl, alkylcarbonyloxy, arylcarbonyloxy, alkoxycarbonyloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, amino (including alkylamino, dialkylamino, arylamino, diarylamino, and alkylarylamino), acylamino (including alkylcarbonylamino, arylcarbonylamino, carbamoyl and ureido), amidino, imino, sulfhydryl, alkylthio, arylthio, thiocarboxylate, sulfates, alkylsulfinyl, sulfonato, sulfamoyl, sulfonamido, nitro, trifluoromethyl, cyano, azido, heterocyclyl, alkylaryl, or an aromatic or heteroaromatic moieties. Examples of halogen substituted alkoxy groups include, but are not limited to, fluoromethoxy, difluoromethoxy, trifluoromethoxy, chloromethoxy, dichloromethoxy and trichloromethoxy.

The term “ester” includes compounds or moieties which contain a carbon or a heteroatom bound to an oxygen atom which is bonded to the carbon of a carbonyl group. The term “ester” includes alkoxycarboxy groups such as methoxycarbonyl, ethoxycarbonyl, propoxycarbonyl, butoxycarbonyl, pentoxycarbonyl, etc.

As used herein, “amino” or “amine,” as used herein, refers to a primary (—NH2), secondary (—NHRx), tertiary (—NRxRy), or quaternary amine (—N+RxRyRz), where Rx, Ry, and Rz are independently an aliphatic, alicyclic, heteroaliphatic, heterocyclic, aryl, or heteroaryl moiety, as defined herein. Examples of amine groups include, but are not limited to, methylamine, dimethylamine, ethylamine, diethylamine, methylethylamine, iso-propylamine, piperidine, trimethylamine, and propylamine. “Alkylamino” includes groups of compounds wherein the nitrogen of —NH2 is bound to at least one alkyl group. Examples of alkylamino groups include benzylamino, methylamino, ethylamino, phenethylamino, etc. “Dialkylamino” includes groups wherein the nitrogen of —NH₂ is bound to two alkyl groups. Examples of dialkylamino groups include, but are not limited to, dimethylamino and diethylamino. “Arylamino” and “diarylamino” include groups wherein the nitrogen is bound to at least one or two aryl groups, respectively. “Aminoaryl” and “aminoaryloxy” refer to aryl and aryloxy substituted with amino. “Alkylarylamino,” “alkylaminoaryl” or “arylaminoalkyl” refers to an amino group which is bound to at least one alkyl group and at least one aryl group. “Alkaminoalkyl” refers to an alkyl, alkenyl, or alkynyl group bound to a nitrogen atom which is also bound to an alkyl group. “Acylamino” includes groups wherein nitrogen is bound to an acyl group. Examples of acylamino include, but are not limited to, alkylcarbonylamino, arylcarbonylamino, carbamoyl and ureido groups.

The term “amide” or “aminocarboxy” includes compounds or moieties that contain a nitrogen atom that is bound to the carbon of a carbonyl or a thiocarbonyl group. The term includes “alkaminocarboxy” groups that include alkyl, alkenyl or alkynyl groups bound to an amino group which is bound to the carbon of a carbonyl or thiocarbonyl group. It also includes “arylaminocarboxy” groups that include aryl or heteroaryl moieties bound to an amino group that is bound to the carbon of a carbonyl or thiocarbonyl group. The terms “alkylaminocarboxy”, “alkenylaminocarboxy”, “alkynylaminocarboxy” and “arylaminocarboxy” include moieties wherein alkyl, alkenyl, alkynyl and aryl moieties, respectively, are bound to a nitrogen atom which is in turn bound to the carbon of a carbonyl group. Amides can be substituted with substituents such as straight chain alkyl, branched alkyl, cycloalkyl, aryl, heteroaryl or heterocycle. Substituents on amide groups may be further substituted.

Unless otherwise specifically defined, the term “aryl” refers to cyclic, aromatic hydrocarbon groups that have 1 to 3 aromatic rings, including monocyclic or bicyclic groups such as phenyl, biphenyl or naphthyl. Where containing two aromatic rings (bicyclic, etc.), the aromatic rings of the aryl group may be joined at a single point (e.g., biphenyl), or fused (e.g., naphthyl). The aryl group may be optionally substituted by one or more substituents, e.g., 1 to 5 substituents, at any point of attachment. Exemplary substituents include, but are not limited to, —H, -halogen, —O—(C1-C6) alkyl, (C1-C6) alkyl, —O—(C2-C6) alkenyl, —O—(C2-C6) alkynyl, (C2-C6) alkenyl, (C2-C6) alkynyl, —OH, —OP(O)(OH)2, —OC(O)(C1-C6) alkyl, —C(O)(C1-C6) alkyl, —OC(O)O(C1-C6) alkyl, NH2, NH((C1-C6) alkyl), N((C1-C6) alkyl)2, —S(O)2-(C1-C6) alkyl, —S(O)NH(C1-C6) alkyl, and —S(O)N((C1-C6) alkyl)2. The substituents can themselves be optionally substituted. Furthermore, when containing two fused rings the aryl groups herein defined may have an unsaturated or partially saturated ring fused with a fully saturated ring. Exemplary ring systems of these aryl groups include, but are not limited to, phenyl, biphenyl, naphthyl, anthracenyl, phenalenyl, phenanthrenyl, indanyl, indenyl, tetrahydronaphthalenyl, tetrahydrobenzoannulenyl, and the like.

Unless otherwise specifically defined, “heteroaryl” means a monocyclic aromatic radical of 5 to 24 ring atoms or a polycyclic aromatic radical, containing one or more ring heteroatoms selected from N, O, or S, the remaining ring atoms being C. Heteroaryl as herein defined also means a bicyclic heteroaromatic group wherein the heteroatom is selected from N, O, or S. The aromatic radical is optionally substituted independently with one or more substituents described herein. Examples include, but are not limited to, furyl, thienyl, pyrrolyl, pyridyl, pyrazolyl, pyrimidinyl, imidazolyl, isoxazolyl, oxazolyl, oxadiazolyl, pyrazinyl, indolyl, thiophen-2-yl, quinolyl, benzopyranyl, isothiazolyl, thiazolyl, thiadiazole, indazole, benzimidazolyl, thieno[3,2-b]thiophene, triazolyl, triazinyl, imidazo[1,2-b]pyrazolyl, furo[2,3-c]pyridinyl, imidazo[1,2-a]pyridinyl, indazolyl, pyrrolo[2,3-c]pyridinyl, pyrrolo[3,2-c]pyridinyl, pyrazolo[3,4-c]pyridinyl, thieno[3,2-c]pyridinyl, thieno[2,3-c]pyridinyl, thieno[2,3-b]pyridinyl, benzothiazolyl, indolyl, indolinyl, indolinonyl, dihydrobenzothiophenyl, dihydrobenzofuranyl, benzofuran, chromanyl, thiochromanyl, tetrahydroquinolinyl, dihydrobenzothiazine, dihydrobenzoxanyl, quinolinyl, isoquinolinyl, 1,6-naphthyridinyl, benzo[de]isoquinolinyl, pyrido[4,3-b][1,6]naphthyridinyl, thieno[2,3-b]pyrazinyl, quinazolinyl, tetrazolo[1,5-a]pyridinyl, [1,2,4]triazolo[4,3-a]pyridinyl, isoindolyl, pyrrolo[2,3-b]pyridinyl, pyrrolo[3,4-b]pyridinyl, pyrrolo[3,2-b]pyridinyl, imidazo[5,4-b]pyridinyl, pyrrolo[1,2-a]pyrimidinyl, tetrahydro pyrrolo[1,2-a]pyrimidinyl, 3,4-dihydro-2H-1?2-pyrrolo[2,1-b]pyrimidine, dibenzo[b,d]thiophene, pyridin-2-one, furo[3,2-c]pyridinyl, furo[2,3-c]pyridinyl, 1H-pyrido[3,4-b][1,4]thiazinyl, benzooxazolyl, benzoisoxazolyl, furo[2,3-b]pyridinyl, benzothiophenyl, 1,5-naphthyridinyl, furo[3,2-b]pyridine, [1,2,4]triazolo[1,5-a]pyridinyl, benzo [1,2,3]triazolyl, imidazo[1,2-a]pyrimidinyl, [1,2,4]triazolo[4,3-b]pyridazinyl, benzo[c][1,2,5]thiadiazolyl, benzo[c][1,2,5]oxadiazole, 1,3-dihydro-2H-benzo[d]imidazol-2-one, 3,4-dihydro-2H-pyrazolo [1,5-b][1,2]oxazinyl, 4,5,6,7-tetrahydropyrazolo[1,5-a]pyridinyl, thiazolo[5,4-d]thiazolyl, imidazo[2,1-b][1,3,4]thiadiazolyl, thieno[2,3-b]pyrrolyl, 3H-indolyl, and derivatives thereof. Furthermore, when containing two fused rings the aryl groups herein defined may have an unsaturated or partially saturated ring fused with a fully saturated ring. Exemplary ring systems of these heteroaryl groups include indolinyl, indolinonyl, dihydrobenzothiophenyl, dihydrobenzofuran, chromanyl, thiochromanyl, tetrahydroquinolinyl, dihydrobenzothiazine, 3,4-dihydro-1H-isoquinolinyl, 2,3-dihydrobenzofuran, indolinyl, indolyl, and dihydrobenzoxanyl.

Furthermore, the terms “aryl” and “heteroaryl” include multicyclic aryl and heteroaryl groups, e.g., tricyclic, bicyclic, e.g., naphthalene, benzoxazole, benzodioxazole, benzothiazole, benzoimidazole, benzothiophene, quinoline, isoquinoline, naphthrydine, indole, benzofuran, purine, benzofuran, deazapurine, indolizine.

“Alkyl” refers to a straight or branched chain saturated hydrocarbon. C1-C6 alkyl groups contain 1 to 6 carbon atoms. Examples of a C1-C6 alkyl group include, but are not limited to, methyl, ethyl, propyl, butyl, pentyl, isopropyl, isobutyl, sec-butyl and tert-butyl, isopentyl and neopentyl.

An optionally substituted alkyl refers to unsubstituted alkyl or alkyl having designated substituents replacing one or more hydrogen atoms on one or more carbons of the hydrocarbon backbone. Such substituents can include, for example, alkyl, alkenyl, alkynyl, halogen, hydroxyl, alkylcarbonyloxy, arylcarbonyloxy, alkoxycarbonyloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, amino (including alkylamino, dialkylamino, arylamino, diarylamino and alkylarylamino), acylamino (including alkylcarbonylamino, arylcarbonylamino, carbamoyl and ureido), amidino, imino, sulfhydryl, alkylthio, arylthio, thiocarboxylate, sulfates, alkylsulfinyl, sulfonato, sulfamoyl, sulfonamido, nitro, trifluoromethyl, cyano, azido, heterocyclyl, alkylaryl, or an aromatic or heteroaromatic moiety.

As used herein, “alkenyl” includes unsaturated aliphatic groups analogous in length and possible substitution to the alkyls described above, but that contain at least one double bond. For example, the term “alkenyl” includes straight chain alkenyl groups (e.g., ethenyl, propenyl, butenyl, pentenyl, hexenyl, heptenyl, octenyl, nonenyl, decenyl), and branched alkenyl groups.

An optionally substituted alkenyl refers to unsubstituted alkenyl or alkenyl having designated substituents replacing one or more hydrogen atoms on one or more hydrocarbon backbone carbon atoms. Such substituents can include, for example, alkyl, alkenyl, alkynyl, halogen, hydroxyl, alkylcarbonyloxy, arylcarbonyloxy, alkoxycarbonyloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, amino (including alkylamino, dialkylamino, arylamino, diarylamino and alkylarylamino), acylamino (including alkylcarbonylamino, arylcarbonylamino, carbamoyl and ureido), amidino, imino, sulfhydryl, alkylthio, arylthio, thiocarboxylate, sulfates, alkylsulfinyl, sulfonato, sulfamoyl, sulfonamido, nitro, trifluoromethyl, cyano, heterocyclyl, alkylaryl, or an aromatic or heteroaromatic moiety.

“Alkynyl” includes unsaturated aliphatic groups analogous in length and possible substitution to the alkyls described above, but which contain at least one triple bond. For example, “alkynyl” includes straight chain alkynyl groups (e.g., ethynyl, propynyl, butynyl, pentynyl, hexynyl, heptynyl, octynyl, nonynyl, decynyl), and branched alkynyl groups. In certain embodiments, a straight chain or branched alkynyl group has six or fewer carbon atoms in its backbone (e.g., C2-C6 for straight chain, C3-C6 for branched chain). The term “C2-C6” includes alkynyl groups containing two to six carbon atoms. The term “C3-C6” includes alkynyl groups containing three to six carbon atoms.

As used herein, the term “molecular weight cutoff” refers to at least 90% (e.g., at least 92%, at least 95%, or at least 98%) rejection rate for molecules with molecular weights greater than the cutoff value.

As used herein, the term “room temperature” can refer to a temperature of about 15° C., about 16° C., about 17° C., about 18° C., about 19° C., about 20° C., about 21° C., about 22° C., about 23° C., about 24° C., or about 25° C. In some embodiments, the room temperature is about 20° C.

As used herein, the term “substantially the same” refers to a first value that is within 10% of a second value. For example, if A is substantially the same as B, and B is 100, A can have a value ranging from 90 to 110. If A is substantially the same as B, and B is 200, A can have a value ranging from 180 to 220.

As used herein, the term “derivative” refers to a compound that is modified from a parent compound, such that the modified compound and the parent compound have a common core structure, while the parent compound is substituted with one or more substituents as described herein to arrive at the modified compound.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto.

### EXAMPLES

### Example 1

A polymer-modified graphene oxide membrane was produced according to the following procedure: (1) 200 mL of a dispersion comprising graphene oxide sheets (GO sheets 110, 4 mg/mL) were treated by adding 200 mL of a NaOH solution 0.5 M (4 g NaOH in 200 mL). (2) the resulting mixture was sonicated for 3 hours. (3) A concentrated solution of HCl was added to the resulting mixture to adjust the pH to ˜7.0. (4) water was added to the resulting mixture to adjust the concentration of graphene oxide sheets to 1 mg/mL (˜800 mL total volume). (5) 20 mL of polyethyleneimine (PEI, 10 mg/mL) were added to the resulting mixture to produce a PEI-GO dispersion. (6). The PEI-GO dispersion was mixed with a high shear mix for 5 min using a general-purpose head. (7) 192 mg of 1-Ethyl-3-(3-dimethylaminopropyl)carbodiimide (EDC) were added to the PEI-GO dispersion, and the resulting dispersion was mixed with the high shear mixer for 30 mins using the general purpose head. (8) The PEI-GO dispersion was then transferred to a 1 Lt reactor and 576 mg of EDC (20 mM) were added. (9) The PEI-GO dispersion was then stirred overnight (e.g., ˜16 hrs) at room temperature (e.g., about 25° C.). (10) The PEI dispersion was subsequently centrifuged at 3800 rpm for 3 hours. (11) The resulting PEI-GO dispersion was filtered with a Buchner funnel, and the filtrate was replaced with RO water to adjust a final total mass of 200 g. The PEI-GO dispersion was subsequently mixed with the high shear mixer at 2000 rpm for 2 hours using an emulsion head.

### Example 2

A polymer-modified graphene oxide membrane was produced according to the following procedure: (1) 500 gr of a dispersion comprising GO sheets (0.4% GO) were added to a 1 Lt reactor and stirred at 300 rpm. (2) 1.62 g of NaOH pellets were dissolved in 300 mL of water to produce a NaOH solution. (3) The NaOH solution was mixed slowly to the dispersion. (4) The resulting mixture was stirred at room temperature for 4 hours and then heated to target temperature of 50° C. (5) A polyethyleneimine (PEI) solution (1% PEI) was prepared and its pH was adjusted to 12.08 by adding a volume of a 2.5% NaOH solution. (6) When the mixture reached the target temperature, the stirring rate was increased to 500 rpm and 12.5 mL of the PEI solution were added to the mixture dropwise to produce a PEI-GO dispersion. (7) After 10 min of stirring at 500 rpm, 0.575 g of 1-Ethyl-3-(3-dimethylaminopropyl)carbodiimide (EDC) were added to the PEI-GO dispersion. (8) The stirring rate of the PEI-GO dispersion was then decreased to 300 rpm and the PEI-GO dispersion was stirred for 16 hours. (9) The PEI-GO dispersion was then cooled to room temperature and mixed with a high shear mixer at 3000 rpm for 80 min using a general purpose head

### Example 3. Graphene Oxide Functionalization Chemistry with 1,4-bis(bromomethyl)benzene Chemical Linker

A graphene oxide membrane was produced according to the following procedure: (1) 0.5 mL of a 0.4 wt % aqueous graphene oxide solution were mixed with 20 mL of water. (2) The solution was casted by vacuum filtration through a 90 mm diameter ultrafiltration membrane (0.45 μm porous PTFE on a PP nonwoven) and allowed to dry. (3) The membrane was soaked in 5 mL acetonitrile and 1 mL thionyl chloride for 1 hour, and then decanted the liquid from the surface of the membrane. (4) 80 mg p-phenylenediamine in 5 mL acetonitrile were added for 3 hours. Solids formed upon addition. (5) The resulting material was washed with DMF, then H₂O, and then dried. (6) The material was soaked in 40 mg 1,4-bis(bromomethyl)benzene and 7 mg 1,4-diazabicyclo[2.2. 2]octane (DABCO) in 2.5 mL DMF, and then was heat at 65° C. for 3 hours. (7) the resulting membrane was washed with H₂O and air dry.

### Example 4. Graphene Oxide Functionalization Chemistry with Acrylamide Spacer 111

A graphene oxide membrane was produced according to the following procedure: (1) 15 mL of 4 mg/mL graphene oxide sheets was treated with 0.1 mL TEA, 22 mg NHS, and 72 mg EDC. (2) The mixture was incubated at room temperature for 1 hour. (3) A 5 mL aliquot of the mixture was treated with 10.6 mg acrylamide. (4) The resulting mixture was heated for 4 hours in an oven at 65° C. (5) The mixture was cooled to room temperature and cast with a 40-gauge rod onto a substrate, dried and washed with DMF/Water.

### Example 5. Graphene Oxide Functionalization Chemistry with Ethylenediamine Linker

A graphene oxide membrane was produced according to the following procedure: (1) 6 mL of 1.0 wt % graphene oxide sheets were added to a scintillation vial. (2) 41 μL of ethylenediamine were added to the scintillation vial. The vial was swirled to dissolve the ethylenediamine. (3) The resulting material was rod casted using a 40-gauge rod and heated at 80° C. for 1 hour. When poly(allyl amine) is used as the polymer additive, the procedure further includes rod casting using a 40-gauge 3.0 mL 2.5 wt % poly(allyl amine) and then air drying in a fume hood for 72 hours

### Example 6. Graphene Oxide Functionalization with Propionamide Spacer 111

A graphene oxide membrane was produced with the following procedure: (1) 15 mL of 4 mg/mL graphene oxide sheets were treated with 0.1 mL TEA. (2) The mixture was incubated at room temperature for 1 hour. (3) A 5 mL aliquot of the mixture was treated with 10.8 mg propionamide. (4) Resulting mixture was heated at 4 hours in a 70° C. oven and washed with DMF/Water. (5) The mixture was cooled to room temperature and cast with a 40-gauge rod onto a substrate, dried and washed with DMF/Water.

### Example 7. Graphene Oxide Membranes with 1,4-bis(bromomethyl)benzene Chemical Linker and Poly(Allylamine HCl) Polymeric Additive

A 2.5 wt % poly(allylamine HCl) polymeric additive layer was deposited onto the graphene oxide membranes described in Example 3. The 2.5 wt % poly (allylamine HCL) polymeric additive layer was deposited according to the following procedure: (1) 19.5 g of water and 0.5 g of Poly(allylamine HCl) polymeric additive were weighted on a balance. (2) The weighted water was added to a vial containing a magnetic stirrer, and the Poly (allylamine HCl) was then slowly mixed under agitation. (3) The resulting polymeric additive mixture was stirred for 1 hr. The polymeric additive mixture exhibited a coloration from light orange to dark orange depending on the concentration of Poly (allylamine HCl) added. (4) dried graphene oxide membranes prepared according to Example 3 were placed over a flat surface and the polymeric additive mixture were subsequently added. (5) The polymeric additive mixture was casted onto the graphene oxide membrane in a single movement using a specific rod size for the desired thickness. (6) The graphene oxide membrane with the casted polymeric additive was dried on the flat surface at room temperature for 12 h in a fume hood, and then dried in an oven at 80° C. for 90 min. The amounts of poly (allylamine HCl) and water used in step (1) were adjusted and the procedure described above was followed in order to prepare 1 wt %, 2 wt %, and 30 wt % poly(allylamine HCl) polymeric additive layers

### Example 8. Graphene Oxide Membranes with 1,4-bis(bromomethyl)benzene Chemical Linker and Polyvinyl Alcohol Polymeric Additive

A 2.5 wt % polyvinyl alcohol polymeric additive layer was deposited onto the graphene oxide membranes described in Example 3. The 2.5 wt % polyvinyl alcohol polymeric additive layer was deposited according to the following procedure: (1) 19.5 g of water and 0.5 g of polyvinyl alcohol polymeric additive were weighted on a balance. (2) The weighted water was added to a vial containing a magnetic stirrer, and the polyvinyl alcohol was slowly mixed under agitation. (3) After completing the addition of the polyvinyl alcohol, the polymeric additive mixture was heated for 1 hour at 90° C. (4) Dried graphene oxide membranes prepared according to Example 3 were placed over a flat surface and the polymeric additive mixture were subsequently added. (5) The polymeric additive mixture was casted onto the graphene oxide membrane in a single movement using a specific rod size for the desired thickness. (6) The graphene oxide membrane with the casted polymeric additive was dried on the flat surface at room temperature for 12 hours in a fume hood, and then dried in an oven at 80° C. for 90 min.

### Example 9. Performance of Graphene Oxide Membranes with Polymeric Additives

Graphene oxide membranes with a poly(allylamine HCl) polymeric additive layer prepared as described in Example 7 were evaluated using the testing procedure outlined in Example 11. The membranes exhibited lactose and salt rejection rates as described in Table 1. The relative difference between the lactose rejection rate and the MgSO₄ rejection rate was calculated as the difference between lactose and MgSO₄ rejection rate divided by the lactose rejection rate multiplied by 100.

TABLE 1

| | | Rod | | Lactose | MgSO₄ | Relative |
|---|---|---|---|---|---|---|
| Polymer/ | Concentration | size for | Flow | rejection | rejection | Difference |
| Additive | (wt %) | coating | (g/mL) | (%) | (%) | (%) |
| No additive | — | — | 0.02 | 93 | 74 | 20 |
| Poly(allylamine | 30 | 10 | 0.005 | 92 | 56 | 39 |
| HCl) | | 20 | 0.004 | 92 | 60 | 35 |
| | | 40 | 0.004 | 85 | 49 | 42 |

### Example 10. Graphene Oxide Membranes with Acrylamide Spacer 111 and Polyacrylamide Polymeric Additive

A 1 wt % polyacrylamide polymeric additive layer was deposited onto the graphene oxide membranes described in Example 4. The 1 wt % polyacrylamide polymeric additive layer was deposited according to the following procedure: (1) 19.8 g of water were added to a vial containing a magnetic stirrer. (2) 0.2 g of Polyacrylamide polymeric additive were weighed and added to the vial under agitation with the aid of the magnetic stirrer. (3) The resulting polymeric additive mixture was stirred for 1 hr. (4) A dried graphene oxide membrane was placed over a flat surface and the polymeric additive mixture were subsequently added. (5) The polymeric additive mixture was casted onto the graphene oxide membrane in a single movement using a specific rod size for the desired thickness. (6) The graphene oxide membrane with the casted polymeric additive was dried on the flat surface at room temperature for 12 hours in a fume hood, and then dried in an oven at 80° C. for 90 min.

The graphene oxide membranes with polyacrylamide polymeric additive were evaluated using the testing procedure outlined in Example 11. The membranes exhibited lactose and salt rejection rates as described in Table 2. The relative difference between the lactose rejection rate and the MgSO4 rejection rate was calculated as the difference between lactose and MgSO4 rejection rates divided by the lactose rejection multiplied by 100.

TABLE 2

| | Experiment A | Experiment B |
|---|---|---|
| Lactose Rejection (%) | 91.23 | 89.06 |
| MgSO₄ Rejection (%) | 44.81 | 52.90 |
| Relative Difference (%) | 50.8 | 40.6 |

### Example 11. Dead End Testing Procedure

Graphene oxide membranes were characterized for rejection and permeability according to the following procedure: (1) cut a 47 to 50 mm disc from the graphene oxide membrane using a razor blade or laser cuter; (2) load the disc with the graphene oxide side up onto a porous stainless steel frit, which is then mounted into a Sterlitech HP4750 filtration cell; (3) add 60 to 100 mL of 1 wt % lactose solution; (4) place the setup on a stir plate at approximately 750 rpm; (4) close the feed chamber and pressurize it to 50 to 100 psi. (5) Approximately 15 to 30 mL of permeate is collected of a 1 wt % lactose and 0.1 wt % MgSO₄ solution at room temperature using 75 psi of driving pressure and ˜500 rpm stir speed.

### Example 12. Graphene Oxide Membranes with Poly(Allylamine HCl) after Exposure to High pH and High Temperature

Graphene oxide membranes were functionalized with propionamide spacer 111 as outlined in Example 6. A 1, 2, and 45 wt % Poly(allylamine HCl) polymeric additive layer as described in Example 7 was deposited onto the propionamide functionalized membranes. The graphene membranes with polymeric additive were exposed to a partial phosphate buffer solution at pH 11.5 and a temperature of 80° C., and then immediately tested as outlined in Example 11 with a 1 wt % lactose solution and a 0.1 wt % MgSO₄ solution. The membranes exhibited lactose and MgSO₄ rejection rates as described in Table 3.

TABLE 3

| | | Rod | | Lactose | MgSO₄ | Relative |
|---|---|---|---|---|---|---|
| Polymer/ | Concentration | size for | Flow | rejection | rejection | Difference |
| Additive | (wt %) | coating | (g/mL) | (%) | (%) | (%) |
| No additive | — | — | 0.01 | 70 | 60 | 14 |
| Poly(allylamine | 1 | 40 | 0.04 | 63 | 14 | 78 |
| HCl) | 2 | | 0.04 | 74 | 34 | 54 |
| | 45 | | 0.05 | 90 | 51 | 43 |

### Example 13. Graphene Oxide Membranes with Acrylamide Spacer 111 and Hydroxypropyl Methyl Cellulose (HPMC) Polymeric Additive Prepared by Co-Casting

A graphene oxide membrane was produced according to the following procedure. (1) 5 mL of 0.4 wt % graphene oxide sheets were mixed with 80 μL of triethylamine (TEA) and 21.2 mg of acrylamide in a 20-dram scintillation vial. (2) The resulting mixture was heated to 70° C. for 4 hours under mechanical stirring. (3) A first 2.5 mL aliquot of the resulting mixture was treated with 25 μL of 10 mg/mL hydroxypropyl methyl cellulose solution (HPMC, 100:1). (4) The resulting material was rod casted with a 20 g rod onto a substrate and was subsequently allowed to dry in a fume hood overnight at room temperature. (5) A second 2.5 mL aliquot of the mixture produced in step (2) prior to addition of HPMC was casted with a 20-gauge rod layer over the material cast in step (4). The resulting graphene oxide membrane was evaluated using the testing procedure outlined in Example 11. The membranes exhibited lactose and salt rejection rates as described in Table 4.

TABLE 4

| | | | | | |
|---|---|---|---|---|---|
| Flow Rate (g/min) | 0.0095 | 0.0158 | 0.1488 | 0.1296 | 0.1186 |
| Sugar Rejection (%) | 81.06 | 92.20 | 59.39 | 58.31 | 69.14 |
| Salt Rejections (%) | 65.28 | 59.35 | 27.93 | 35.07 | 44.01 |

### Example 14. Graphene Oxide Membranes with Acrylamide Spacer 111 and Polyacrylamide Polymeric Additive Prepared by Co-Casting

A graphene oxide membrane was produced according to the following procedure. (1) 5 mL of 0.4 wt % graphene oxide sheets were mixed with 80 μL of TEA and 21.2 mg of acrylamide in a 20-dram scintillation vial. (2) The resulting mixture was heated to 70° C. for 4 hours under mechanical stirring. (3) A first 2.5 mL aliquot of the resulting mixture was treated with 25 μL of 10 mg/mL polyacrylamide (100:1). (4) The resulting material was rod cast with a 20 g rod onto a substrate and was subsequently allowed to dry in a fume hood overnight at room temperature. (5) A second 2.5 mL aliquot of the mixture produced in step (2) prior to addition of polyacrylamide was cast with a 20-gauge rod layer over the material cast in step (4). The resulting graphene oxide membrane was evaluated using the testing procedure outlined in Example 11. The membranes exhibited lactose and salt rejection rates as described in Table 5.

TABLE 5

| | | |
|---|---|---|
| Flow Rate (g/min) | 0.0145 | 0.0131 |
| Sugar Rejection (%) | 77.17 | 91.23 |
| Salt Rejection (%) | 57.69 | 44.81 |

### Example 15. Graphene Oxide Membranes with Ethylenediamine Linker and Poly (Allylamine HCl) Polymeric Additive

A graphene oxide membrane was produced according to the procedure described in Example 5. The resulting graphene oxide membrane was evaluated using the testing procedure outlined in Example 11. The membranes exhibited lactose and salt rejection rates as described in Table 6.

TABLE 6

| | | | | | |
|---|---|---|---|---|---|
| Flow Rate (g/min) | 0.0045 | 0.0045 | 0.0259 | 0.0340 | 0.0301 |
| Sugar Rejection (%) | 80.32 | 82.26 | 78.17 | 87.69 | 84.13 |
| Salt Rejection (%) | 63.19 | 64.73 | 33.03 | 48.15 | 43.43 |

### Example 16. Graphene Oxide Membranes with 1,4-Phenylenediamine Sulfonic Acid and Poly (Allylamine HCl) Polymeric Additive

A graphene oxide membrane was produced according to the following procedure: (1) 6 mL of 1.0 wt % graphene oxide sheets were added to a 20-dram scintillation vial. (2) 113 mg 1,4-phenylenediamine sulfonic acid were added to the scintillation vial. The vial was swirled to dissolve the 1,4-phenylenediamine. (3) The resulting material was rod cast using a 40-gauge rod and heated at 80° C. for 1 hour and subsequently cooled to room temperature. (4) A 3.0 mL aliquot of 2.5 wt % poly(allylamine HCl) polymeric additive solution was prepared, rod casted over the graphene membrane obtained in step (3), and allowed to dry in a fume hood for 72 hours at room temperature. The resulting graphene oxide membrane was evaluated using the testing procedure outlined in Example 11. The membranes exhibited lactose and salt rejection rates as described in Table 7.

TABLE 7

| | | | | | | |
|---|---|---|---|---|---|---|
| Flow Rate (g/min) | — | — | 0.0364 | 0.0194 | 0.0310 | 0.0273 |
| Sugar Rejection (%) | 69.84 | 75.72 | 75.66 | 74.41 | 83.48 | 81.06 |
| Salt Rejection (%) | 44.86 | 51.28 | 29.13 | 37.10 | 49.51 | 47.46 |

1. A filtration apparatus, comprising:
a support substrate; and
a graphene oxide membrane disposed on the support substrate, the graphene oxide membrane including a plurality of graphene oxide sheets, each of the graphene oxide sheets from the plurality of graphene oxide sheets coupled to a polymeric component,
wherein:
the graphene oxide membrane has a total solids rejection rate of at least about 50% and a flux of at least about 4 gallons per square foot per day (GFD) in flowing a weak black liquor solution at a cross flow velocity of at least about 0.1 m/sec at a predetermined temperature and a pressure of at least about 100 psi.

2. The filtration apparatus of claim 1, wherein the flowing weak black liquor comprises sodium sulfate, sodium carbonate, sodium hydrosulfide, sodium thiosulfate, sodium hydroxide, tall oils, carbohydrates, lignin, cellulose, hemicellulose, or a combination thereof.

3. The filtration apparatus of claim 1, wherein the weak black liquor solution contains between about 2 and 20 wt. % total dissolved solids and the predetermined temperature is at least about 50° C.

4. The filtration apparatus of claim 1, wherein each of the graphene oxide sheets from the plurality of graphene oxide sheets is covalently coupled to the polymeric component.

5. The filtration apparatus of claim 4, wherein the polymeric component includes amine functional groups, the amine functional groups being covalently coupled to the plurality of graphene oxide sheets.

6. The filtration apparatus of claim 5, wherein the polymeric component includes polyethyleneimine.

7. The filtration apparatus of claim 6, wherein the polyethyleneimine has an average molecular weight of at least about 1,800 Da.

8. The filtration apparatus of claim 6, wherein the polyethyleneimine has an average molecular weight of about 25,000 Da.

9. The filtration apparatus of claim 1, wherein the weak black liquor solution has a pH of at least about 11.

10. The filtration apparatus of claim 1, wherein each of the graphene oxide sheets from the plurality of graphene oxide sheets has a carbon to oxygen ratio (C:O) of at least about 1.5:1.

11. A method for fabricating a graphene oxide membrane, including:
dispersing a plurality of graphene oxide sheets in an aqueous solution;
adjusting a pH of the aqueous solution to between about 7.0 to 10;
adding a polymeric component and at least one carbodiimide additive to the aqueous solution;
after adding the polymeric component and the at least one carbodiimide additive, stirring the aqueous solution for a period of time at a predetermined temperature;
after the adding and the stirring, casting the aqueous solution on a support substrate; and
drying the aqueous solution on the support substrate to produce the graphene oxide membrane.

12. The method of claim 10, wherein each graphene oxide sheet from the plurality of graphene oxide sheets has a carbon to oxygen ratio (C:O) of at least about 1.5:1.

13. The method of claim 10, wherein the polymeric component includes amine functional groups.

14. The method of claim 13, wherein the polymeric component includes polyethyleneimine.

15. The filtration apparatus of claim 14, wherein the polyethyleneimine has an average molecular weight of at least about 1,800 Da.

16. The filtration apparatus of claim 14, wherein the polyethyleneimine has an average molecular weight of about 25,000 Da.

17. A filtration apparatus, comprising:
a support;
a graphene oxide membrane disposed on the support, the graphene oxide membrane comprising a plurality of graphene oxide layers, each graphene oxide layer including at least one graphene oxide sheet covalently coupled to a chemical spacer; and
a polymeric additive disposed on the graphene oxide membrane,
wherein: the filtration apparatus is characterized by a lactose rejection rate with a 1 wt % lactose solution and a MgSO₄ rejection rate with a 0.1 wt % MgSO₄ solution, the lactose rejection rate being at least about 20% greater than the MgSO₄ rejection rate.

18. The filtration apparatus of claim 17, wherein the polymeric additive comprises poly (allyl amine), poly(allylamine hydrochloride), dopamine, hydroxypropyl methylcellulose, polyethyleneimine, polyacrylamide, or a combination thereof.

19. The filtration apparatus of claim 18, wherein the poly (allyl amine hydrochloride) has a molecular weight of at least 120,000.

20. The filtration apparatus of claim 19, wherein the poly (allyl amine hydrochloride) has a molecular weight of no more than about 200,000.
